(19) United States
(12) Patent Application Publication
(10) Pub. No.: US 2005/0141778 A1
(43) Pub. Date: Jun. 30, 2005

(54) Image processing method, image processing apparatus and image processing program

(75) Inventors: Takeshi Nakajima, Tokyo (JP); Tsukasa Ito, Tokyo (JP); Hideyuki Kobayashi, Tokyo (JP); Hiroaki Takano, Tokyo (JP); Daisuke Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA PHOTO IMAGING, INC.

(21) Appl. No.: 11/017,780

(22) Filed: Dec. 22, 2004

(30) Foreign Application Priority Data
Dec. 26, 2003 (JP) JP2003-435414

(51) Int. Cl. G06K 9/00; G06K 9/40

(52) U.S. Cl. 382/254; 382/276

(57) ABSTRACT

The present invention relates to a processing the processing can be applied without generating the deterioration of the sharpness when the puckering or spotting is removed from the face or neck of the portrait. To solve the above problem, an image signal expressing a color image is obtained, and the pixels forming the skin-color signal, are extracted from the pixels included in the image signal, and in the extracted pixels, on the pixels in which the spatial frequency is within a specific range, and a variation amount of the signal intensity is not larger than specific threshold value, the image processing to reduce a variation amount of the signal intensity, is applied.

### FIELD OF THE INVENTION

The present invention relates to an image processing method, image processing apparatus and image processing program.

### BACKGROUND OF THE INVENTION

Conventionally, in a portrait photographing using a silver halide film in a portrait studio, a correction processing is applied to a print or a negative film by a manual working so that a puckering or spotting of a face portion or a neck portion of a person is lightened or erased.

Further, recently, a development of a digital still camera (hereinafter, called DSC) is conspicuous, and a single-lens reflex type DSC having a resolving power not smaller than 10⁷ pixels is put on the market, and also in the portrait photographing in the portrait studio, by using a high resolving power DSC, the photographing is conducted.

Accordingly, in Patent Document 1, an image processing method by which a removal of a puckering or spotting portion can be effectively applied to the face of a person included in an image made by DSC, is proposed.

(Patent Document 1) Tokkai 2003-209683

However, in the method of Patent Document 1, an operator indicates and inspects a correction of red-eye or a removal of a puckering or spotting after an extraction of a face area included in the image. Therefore, the productivity is low, and depending on the operator's inspection, there is a possibility that the sharpness of the whole image is deteriorated, or an outline structure of the face of a person is changed, and the image becomes an image having a sense of incompatibility.

### SUMMARY OF THE INVENTION

A problem of the present invention is to make it possible to remove easily the puckering or spotting without the sense of incompatibility when the puckering or spotting is removed from a face or neck of the portrait image, without deteriorating the sharpness feeling of the whole image, or without changing the outline structure of a face of a person.

To solve the above problem, the present invention provides an image processing method, apparatus and program in which an image signal expressing a color image is obtained, the pixels forming the skin-colored area are extracted from the pixels included in the image signal, and when the pixels has the spatial frequency within a specific range and the signal intensity whose variation amount is not larger than specific threshold value among the extracted pixels, a variation amount of the signal intensity of the pixels are reduced.

### BRIEF DESCRIPTION OF THE DRAWINGS

FIG. 1 is a view showing the wavelet function used in the multiresolution transform according to the present invention.

FIG. 2 is a view showing a flow of a filter processing of 1-level wavelet transform.

FIG. 3 is a system block diagram showing a flow of a filter processing of 1-level wavelet transform.

FIG. 4 is a typical view showing a process in which a signal is decomposed by 3-level wavelet transform.

FIG. 5 is a system block diagram for re-structuring a signal before decomposition by the filter processing of the inverse wavelet transform.

FIGS. 6(a)-6(e) are views showing a waveform of an input signal S₀ and a waveform of corrected higher frequency band component Wᵢ-γᵢ of each level obtained by the wavelet transform.

FIG. 7 is a system block diagram showing a flow of the filter processing of a 1-level dyadic wavelet transform.

FIG. 8 is a view showing a flow of the filter processing of a 1-level inverse dyadic wavelet transform.

FIG. 9 is a system block diagram showing a flow of a processing from the dyadic wavelet transform to a time point when the signal S₀′ on which the image processing is applied, is obtained.

FIG. 10 is a perspective view showing an outline structure of an image recording apparatus.

FIG. 11 is a block diagram showing an internal structure of the image recording apparatus.

FIG. 12 is a block diagram showing a functional structure of an image processing section of FIG. 11.

FIG. 13 is a system block diagram according to the internal processing of an image adjustment processing section in Example 1.

FIG. 14 is a view showing an image evaluation result when a plurality of image processing in which image processing conditions in Example 1 are different, are applied.

FIG. 15 is a system block diagram according to the internal processing of the image adjustment processing section in Example 2.

### DETAILED DESCRIPTION OF THE INVENTION

Preferred embodiments of the present invention will be described below.

To solve the above problem, an embodiment written in item 1 is an image processing method including an obtaining step of obtaining an image signal representing a color image, an extracting step of extracting pixels which form a skin colored area from pixels which are included in the obtained image signal, a signal intensity adjusting step of reducing a variation amount of a signal intensity of a pixel whose spatial frequency is in a predetermined range and whose signal intensity variation amount is a predetermined threshold or below among the extracted pixels.

Further, as an embodiment written in item 2, in the embodiment written in item 1, it is preferable that the extracting step extracts pixels which form a skin colored area by applying a dyadic wavelet transform to the obtained image signal and applying a simple area expansion to a lower frequency band component of the transformed image signal.

As an embodiment written in item 3, in the embodiment written in item 1 or item 2, it is preferable that the spatial frequency within the predetermined range is obtained by a higher frequency band component calculated by a multiresolution transform.

As an embodiment written in item 4, in the embodiment written in item 3, it is preferable that the signal intensity adjusting step determines the predetermined threshold based on a statistic value calculated by the higher frequency band component of an image signal intensity.

As an embodiment written in item 5, in the embodiment written in item 4, it is preferable that the statistic value is one of a standard deviation, an average, a median and a mode.

As an embodiment written in item 6, in the embodiment written in any one of items 1-5, it is preferable that when a pixel among the extracted pixels has a spatial frequency of 1.5-3.0 lines/mm and a signal intensity variation is in a range between 0-20% of a maximum signal intensity, the signal intensity adjusting step reduces a variation amount of a signal intensity of the pixel by 0.5-0.75 times.

As an embodiment written in item 7, in the embodiment written in any one of items 1-6, it is preferable that the image processing method further comprise: a color information converting step of converting the obtained image signal into a brightness signal and a color-difference signal, wherein the signal intensity regulating step is applied to the brightness signal and/or the color-difference signal of the extracted pixels which form a skin colored area.

As an embodiment written in item 8, in the embodiment written in item 7, it is preferable that the image processing method further comprise: a contrast controlling step of controlling a contrast of an image signal of the extracted pixels which form a skin colored area and whose image signal is reduced in the signal intensity adjusting step.

As an embodiment written in item 9, in the embodiment written in item 7 or item 8, it is preferable that the image processing method further comprise: a noise adding step of adding a noise signal to the image signal of the extracted pixels which form a skin colored area and whose image signal is reduced by the signal intensity regulating step.

To solve the above problem, an embodiment written in item 10 is an image processing method of item 1 further including a color information converting step of converting the obtained image signal into a brightness signal and a color-difference signal; and a wavelet transform step of decomposing the converted image signal into image signals with different frequency band components by applying at least a second level dyadic wavelet transform to the converted image signal, wherein when an image signal intensity in at least a higher frequency band component at level 2 of the extracted pixels among the decomposed frequency band components is predetermined threshold value or below, the image intensity adjusting step reduces the signal intensity.

In other words, the embodiment written in item 10 is an image processing method including an obtaining step of obtaining an image signal representing a color image; an extracting step of extracting pixels which form a skin colored area from pixels which are included in the obtained image signal; a color information converting step of converting the obtained image signal into a brightness signal and a color-difference signal; a wavelet transform step of decomposing the converted image signal into image signals with different frequency band components by applying at least a second level dyadic wavelet transform to the converted image signal; and a signal intensity adjusting step of reducing a variation amount of a signal intensity of a pixel whose spatial frequency is in a predetermined range and whose signal intensity variation is a predetermined threshold or below among the transformed pixels.

As an embodiment written in item 11, in the embodiment written in items 10, it is preferable that the wavelet transform step applies the dyadic wavelet transform to the brightness signal and/or the color-difference signal.

As an embodiment written in item 12, in the embodiment written in item 11, it is preferable that the image processing method further comprise a contrast controlling step of controlling a contrast of a image signal in the lower frequency band component of the extracted pixels which form a skin colored area among the image signals with different frequency band components decomposed by at least a first level of dyadic wavelet transform in the wavelet transform step.

As an embodiment written in item 13, in the embodiment written in item 11 or item 12, it is preferable that the image processing method further comprise: a noise adding step of adding a noise signal to the image signal of the extracted pixels which form a skin colored area and whose image signal is reduced by the signal intensity regulating step.

To solve the above problem, an embodiment written in item 14 is an image processing method of item 1 further comprise: a first transform step and a second transform step, wherein the first transform step decomposes the obtained image signal into image signals with different frequency band components by applying at least the first level multiresolution transform which is a method of reducing an image size, the extracting step extracts pixels which form skin colored area from pixels included in the image signal with a lower frequency band component among image signals with different frequency band components decomposed by the multiresoluting transform, the second transform step decomposes the image signal with the lower frequency band component into image signals with different frequency band components using at least a first level dyadic wavelet transform, and when an intensity of an image signal in a higher frequency band component of the extracted pixels which form a skin colored area among image signals in different frequency band components decomposed by the dyadic wavelet transform, the signal intensity adjusting step reduces the signal intensity.

In other words, the embodiment written in item 14 is an image processing method including:

an obtaining step of obtaining an image signal representing a color image; a first transform step of decomposing the obtained image signal into image signals with different frequency band components by applying at least the first level multiresolution transform which is a method of reducing an image size; an extracting step of extracting pixels which form a skin colored area from pixels included in the image signal in a lower frequency band component among image signals with different frequency band components decomposed by the multiresoluting transform; a second transform step of decomposing the image signal in the lower frequency band component into image signals with different frequency band components using at least a first level dyadic wavelet transform; a signal intensity adjusting, step of reducing the signal intensity when an intensity of an image signal in a higher frequency band component of the extracted pixels which form a skin colored area among image signals in different frequency band components decomposed by the dyadic wavelet transform.

As an embodiment written in item 15, in the embodiment written in item 14, it is preferable that the image processing method further comprise: a color information converting step of converting the image signal with a lower frequency band component among the decomposed frequency band components into a brightness signal and a color-difference signal, wherein the second transform step applies at least a first level dyadic wavelet transform to the brightness signal and/or the color-difference signal.

As an embodiment written in item 16, in the embodiment written in item 15, it is preferable that the image processing method further comprises: a contrast controlling step of controlling a contrast of a image signal of the extracted pixels which form a skin colored area.

As an embodiment written in item 17, in the embodiment written in item 15 or item 16, it is preferable that the image processing method further comprise: a noise adding step of adding a noise signal to the image signal of the extracted pixels which form a skin colored area and whose image signal is reduced by the signal intensity regulating step.

To solve the above problem, an embodiment written in item 18 is an image processing apparatus including an obtaining an obtaining section of obtaining an image signal representing a color image, an extracting section of extracting pixels which form a skin colored area from pixels which are included in the obtained image signal; a signal intensity adjusting section of reducing a variation amount of a signal intensity of a pixel whose spatial frequency is in a predetermined range and whose signal intensity variation amount is a predetermined threshold or below among the extracted pixels.

Further, as an embodiment written in item 19, in the embodiment written in item 18, it is preferable that the extracting section extracts pixels which form a skin colored area by applying a dyadic wavelet transform to the obtained image signal and applying a simple area expansion to a lower frequency band component of the transformed image signal.

As an embodiment written in item 20, in the embodiment written in item 18 or item 19, it is preferable that the spatial frequency within the predetermined range is obtained by a higher frequency band component calculated by a multiresolution transform.

As an embodiment written in item 21, in the embodiment written in item 20, it is preferable that the signal intensity adjusting section determines the predetermined threshold based on a statistic value calculated by the higher frequency band component of an image signal intensity.

As an embodiment written in item 22, in the embodiment written in item 21, it is preferable that the statistic value is one of a standard deviation, an average, a median and a mode.

As an embodiment written in item 23, in the embodiment written in any one of items 18-22, it is preferable that when a pixel among the extracted pixels has a spatial frequency of 1.5-3.0 lines/mm and a signal intensity variation is in a range between 0-20% of a maximum signal intensity, the signal intensity adjusting section reduces a variation amount of a signal intensity of the pixel by 0.5-0.75 times.

As an embodiment written in item 24, in the embodiment written in any one of items 18-23, it is preferable that the image processing apparatus further comprise: a color information converting section of converting the obtained image signal into a brightness signal and a color-difference signal, wherein the signal intensity regulating section is applied to the brightness signal and/or the color-difference signal of the extracted pixels which form a skin colored area.

As an embodiment written in item 25, in the embodiment written in item 24, it is preferable that the image processing apparatus further comprise: a contrast controlling section of controlling a contrast of an image signal of the extracted pixels which form a skin colored area and whose image signal is reduced in the signal intensity adjusting section.

As an embodiment written in item 26, in the embodiment written in item 24 or item 25, it is preferable that the image processing apparatus further comprise: a noise adding section of adding a noise signal to the image signal of the extracted pixels which form a skin colored area and whose image signal is reduced by the signal intensity regulating section.

To solve the above problem, an embodiment written in item 27 is an image processing apparatus of item 18 further including a color information converting section of converting the obtained image signal into a brightness signal and a color-difference signal; and a wavelet transform section of decomposing the converted image signal into image signals with different frequency band components by applying at least a second level dyadic wavelet transform to the converted image signal, wherein when an image signal intensity in at least a higher frequency band component at level 2 of the extracted pixels among the decomposed frequency band components is predetermined threshold value or below, the image intensity adjusting section reduces the signal intensity.

In other words, the embodiment written in item 27 is an image processing apparatus including an obtaining section for obtaining an image signal representing a color image; an extracting section for extracting pixels which form a skin colored area from pixels which are included in the obtained image signal; a color information converting section for converting the obtained image signal into a brightness signal and a color-difference signal; a wavelet transform section for decomposing the converted image signal into image signals with different frequency band components by applying at least a second level dyadic wavelet transform to the converted image signal; and a signal intensity adjusting section for reducing a variation amount of a signal intensity of a pixel whose spatial frequency is in a predetermined range and whose signal intensity variation is a predetermined threshold or below among the transformed pixels.

As an embodiment written in item 28, in the embodiment written in items 27, it is preferable that the wavelet transform section applies the dyadic wavelet transform to the brightness signal and/or the color-difference signal.

As an embodiment written in item 29, in the embodiment written in item 28, it is preferable that the image processing apparatus further comprise a contrast controlling section of controlling a contrast of a image signal in the lower frequency band component of the extracted pixels which form a skin colored area among the image signals with different frequency band components decomposed by at least a first level of dyadic wavelet transform in the wavelet transform section.

As an embodiment written in item 30, in the embodiment written in item 28 or item 29, it is preferable that the image processing apparatus further comprise: a noise adding section of adding a noise signal to the image signal of the extracted pixels which form a skin colored area and whose image signal is reduced by the signal intensity regulating section.

To solve the above problem, an embodiment written in item 31 is an image processing apparatus of item 18 further comprise: a first transform section and a second transform section, wherein the first transform section decomposes the obtained image signal into image signals with different frequency band components by applying at least the first level multiresolution transform which is a apparatus of reducing an image size, the extracting section extracts pixels which form skin colored area from pixels included with the image signal in a lower frequency band component among image signals with different frequency band components decomposed by the multiresoluting transform, the second transform section decomposes the image signal with the lower frequency band component into image signals with different frequency band components using at least a first level dyadic wavelet transform, and when an intensity of an image signal with a higher frequency band component of the extracted pixels which form a skin colored area among image signals in different frequency band components decomposed by the dyadic wavelet transform, the signal intensity adjusting section reduces the signal intensity.

In other words, the embodiment written in item 31 is an image processing apparatus including: an obtaining section for of obtaining an image signal representing a color image; a first transform section for decomposing the obtained image signal into image signals with different frequency band components by applying at least the first level multiresolution transform which is a method of reducing an image size; an extracting section for extracting pixels which form a skin colored area from pixels included in the image signal in a lower frequency band component among image signals with different frequency band components decomposed by the multiresoluting transform; a second transform section for decomposing the image signal in the lower frequency band component into image signals with different frequency band components using at least a first level dyadic wavelet transform; a signal intensity adjusting section for reducing the signal intensity when an intensity of an image signal in a higher frequency band component of the extracted pixels which form a skin colored area among image signals in different frequency band components decomposed by the dyadic wavelet transform.

As an embodiment written in item 32, in the embodiment written in item 31, it is preferable that the image processing apparatus further comprise: a color information converting section of converting the image signal with a lower frequency band component among the decomposed frequency band components into a brightness signal and a color-difference signal, wherein the second transform section applies at least a first level dyadic wavelet transform to the brightness signal and/or the color-difference signal.

As an embodiment written in item 33, in the embodiment written in item 32, it is preferable that the image processing apparatus further comprise: a contrast controlling section of controlling a contrast of a image signal of the extracted pixels which form a skin colored area.

As an embodiment written in item 34, in the embodiment written in item 32 or item 33, it is preferable that the image processing apparatus further comprise: a noise adding section of adding a noise signal to the image signal of the extracted pixels which form a skin colored area and whose image signal is reduced by the signal intensity regulating section.

To solve the above problem, an embodiment written in item 35 is an image processing program for use in a computer executing an image processing, including an obtaining an obtaining step of obtaining an image signal representing a color image, an extracting step of extracting pixels which form a skin colored area from pixels which are included in the obtained image signal; a signal intensity adjusting step of reducing a variation amount of a signal intensity of a pixel whose spatial frequency is in a predetermined range and whose signal intensity variation amount is a predetermined threshold or below among the extracted pixels.

Further, as an embodiment written in item 36, in the embodiment written in item 35, it is preferable that the extracting step extracts pixels which form a skin colored area by applying a dyadic wavelet transform to the obtained image signal and applying a simple area expansion to a lower frequency band component of the transformed image signal.

As an embodiment written in item 37, in the embodiment written in item 35 or item 36, it is preferable that the spatial frequency within the predetermined range is obtained by a higher frequency band component calculated by a multiresolution transform.

As an embodiment written in item 38, in the embodiment written in item 37, it is preferable that the signal intensity adjusting step determines the predetermined threshold based on a statistic value calculated by the higher frequency band component of an image signal intensity.

As an embodiment written in item 39, in the embodiment written in item 38, it is preferable that the statistic value is one of a standard deviation, an average, a median and a mode.

As an embodiment written in item 40, in the embodiment written in any one of items 35-39, it is preferable that when a pixel among the extracted pixels has a spatial frequency of 1.5-3.0 lines/mm and a signal intensity variation is in a range between 0-20% of a maximum signal intensity, the signal intensity adjusting step reduces a variation amount of a signal intensity of the pixel by 0.5-0.75 times.

As an embodiment written in item 41, in the embodiment written in any one of items 35-40, it is preferable that the image processing program further comprise: a color information converting step of converting the obtained image signal into a brightness signal and a color-difference signal, wherein the signal intensity regulating step is applied to the brightness signal and/or the color-difference signal of the extracted pixels which form a skin colored area.

As an embodiment written in item 42, in the embodiment written in item 41, it is preferable that the image processing program further comprise: a contrast controlling step of controlling a contrast of an image signal of the extracted pixels which form a skin colored area and whose image signal is reduced in the signal intensity adjusting step.

As an embodiment written in item 43, in the embodiment written in item 41 or item 42, it is preferable that the image processing program further comprise: a noise adding step of adding a noise signal to the image signal of the extracted pixels which form a skin colored area and whose image signal is reduced by the signal intensity regulating step.

To solve the above problem, an embodiment written in item 44 is an image processing program of item 35 further including a color information converting step of converting the obtained image signal into a brightness signal and a color-difference signal; and a wavelet transform step of decomposing the converted image signal into image signals with different frequency band components by applying at least a second level dyadic wavelet transform to the converted image signal, wherein when an image signal intensity in at least a higher frequency band component at level 2 of the extracted pixels among the decomposed frequency band components is predetermined threshold value or below, the image intensity adjusting step reduces the signal intensity.

In other words, an embodiment written in item 44 is an image processing program including an obtaining step of obtaining an image signal representing a color image; an extracting step of extracting pixels which form a skin colored area from pixels which are included in the obtained image signal; a color information converting step of converting the obtained image signal into a brightness signal and a color-difference signal; a wavelet transform step of decomposing the converted image signal into image signals with different frequency band components by applying at least a second level dyadic wavelet transform to the converted image signal; and a signal intensity adjusting step of reducing a variation amount of a signal intensity of a pixel whose spatial frequency is in a predetermined range and whose signal intensity variation is a predetermined threshold or below among the transformed pixels.

As an embodiment written in item 45, in the embodiment written in items 44, it is preferable that the wavelet transform step applies the dyadic wavelet transform to the brightness signal and/or the color-difference signal.

As an embodiment written in item 46, in the embodiment written in item 45, it is preferable that the image processing program further comprise a contrast controlling step of controlling a contrast of a image signal in the lower frequency band component of the extracted pixels which form a skin colored area among the image signals with different frequency band components decomposed by at least a first level of dyadic wavelet transform in the wavelet transform step.

As an embodiment written in item 47, in the embodiment written in item 45 or item 46, it is preferable that the image processing program further comprise: a noise adding step of adding a noise signal to the image signal of the extracted pixels which form a skin colored area and whose image signal is reduced by the signal intensity regulating step.

To solve the above problem, an embodiment written in item 48 is an image processing program of item 35 further comprise: a first transform step and a second transform step, wherein the first transform step decomposes the obtained image signal into image signals with different frequency band components by applying at least the first level multiresolution transform which is a program of reducing an image size, the extracting step extracts pixels which form skin colored area from pixels included in the image signal with a lower frequency band component among image signals with different frequency band components decomposed by the multiresoluting transform, the second transform step decomposes the image signal in the lower frequency band component into image signals with different frequency band components using at least a first level dyadic wavelet transform, and the signal intensity adjusting step reduces the signal intensity when an intensity of an image signal with a higher frequency band component of the extracted pixels which form a skin colored area among image signals in different frequency band components decomposed by the dyadic wavelet transform.

In other words, the embodiment written in item 48 is an image processing program including: an obtaining step of obtaining an image signal representing a color image; a first transform step of decomposing the obtained image signal into image signals with different frequency band components by applying at least the first level multiresolution transform which is a method of reducing an image size; an extracting step of extracting pixels which form a skin colored area from pixels included in the image signal in a lower frequency band component among image signals with different frequency band components decomposed by the multiresoluting transform; a second transform step of decomposing the image signal in the lower frequency band component into image signals with different frequency band components using at least a first level dyadic wavelet transform; a signal intensity adjusting step of reducing the signal intensity when an intensity of an image signal in a higher frequency band component of the extracted pixels which form a skin colored area among image signals in different frequency band components decomposed by the dyadic wavelet transform.

As an embodiment written in item 49, in the embodiment written in item 48, it is preferable that the image processing program further comprise: a color information converting step of converting the image signal with a lower frequency band component among the decomposed frequency band components into a brightness signal and a color-difference signal, wherein the second transform step applies at least a first level dyadic wavelet transform to the brightness signal and/or the color-difference signal.

As an embodiment written in item 50, in the embodiment written in item 49, it is preferable that the image processing program further comprise: a contrast controlling step of controlling a contrast of a image signal of the extracted pixels which form a skin colored area.

As an embodiment written in item 51, in the embodiment written in item 49 or item 50, it is preferable that the image processing program further comprise: a noise adding step of adding a noise signal to the image signal of the extracted pixels which form a skin colored area and whose image signal is reduced by the signal intensity regulating step.

Herein, terms written in items will be additionally described.

The “skin-colored area” means an area of the skin of the face or neck of a person included in an image signal. Hereupon, as a method to extract the skin-colored area, an image area obtained from the image signal with the lower frequency band components obtained when the dyadic wavelet transform is applied on the image signal, and from the pixels, when a simple range extension is applied, may also be defined as a skin-colored area, or centering around a most suitable eye of the object included in the image signal, the logarithmic polar coordinate transform is applied, and from the image signal after the processing, when a template matching or simple range extension is applied, a range judged as a most suitable face may also be defined as a skin-colored area, or the publicly-known extraction method may also be used.

“Spatial frequency” means a spatial frequency when the image signal is outputted on a printing paper, hard copy, and display device, and “variation amount of the signal intensity” means the difference between a signal intensity of a certain pixel, and the signal intensity of the pixel which is regulated by the spatial frequency.

A phrase “the image signal is converted into the brightness signal and the color difference signal” means, for example, a intensity signal for 3 colors of RGB representing the image signal of an object of the image processing, is converted into a intensity signal for the publicly known YIQ base or YUV base, or converted into a intensity signal for XYZ base of the CIE 1931 color specification system or L*a*b base or L*u*V* base which is advised by CIE 1976 according to a standard such as sRGB (standard RGB) or NTSC (National TV Standards Committee). Further, it may also means a conversion such that an average of RGB values of the signal is defined to the brightness signal, and 2-axis perpendicular to the brightness signal is defined to a color difference signal.

“Image size” means the number of pixels when the image including a color photographic film is photo-electrically read by a CCD sensor and converted into the image signal.

Further, “multiresolution transform” is remarked a general name of methods represented by the wavelet transform, perfect reconstruction filter banks, Laplacian pyramid. “multiresolution transform” is a transform for obtaining a multiresolution signal having a plurality of signal components with different frequency bands from an input signal, such that the input signal is decomposed to the lower frequency band component signal and the higher frequency band component signal by 1-time transform operation and the same transform operations are applied to the obtained lower frequency band component signal. When the inverse multiresolution transform is applied to the obtained multiresolution signal without any processing as it is, the original signal is re-structured.

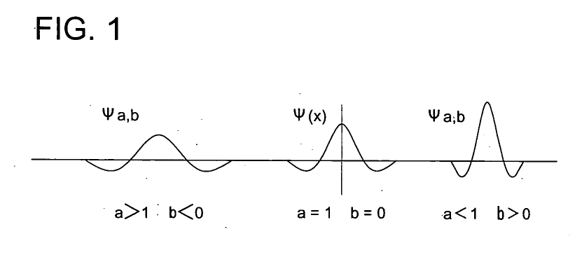

Herein, as a representative example of the multiresolution transform, an outline of the wavelet transform will be described. The wavelet transform is a transform for decomposing an input signal f(x) into the total sum of wavelet functions shown in the following expression (3), such that the wavelet transform function (f, φ_{a,b}) for the input signal f(x) is found as in the following expression (2) by using the wavelet function (the following expression (1)) which is oscillated in the finite range as shown in FIG. 1.

$$\begin{matrix}\text{(Math-1)} & \\ {Ψ}_{a , b} ( x ) = Ψ ( \frac{x - b}{a} ) & ( 1 ) \\ \text{(Math-2)} & \\ 〈 f , {Ψ}_{a , b} 〉 ≡ \frac{1}{a} \int f ( x ) \cdot Ψ ( \frac{x - b}{a} ) ⅆ x & ( 2 ) \\ \text{(Math-3)} & \\ f ( x ) = {\sum }_{a , b} 〈 f , {Ψ}_{a} {,}_{b} 〉 \cdot {Ψ}_{a} {,}_{b} ( x ) & ( 3 )\end{matrix}$$

In the above expressions (1)-(3), a expresses a scale of the wavelet function and b shows a position of the wavelet function. As illustrated in FIG. 1, the larger a value of the scale a is, the smaller the frequency of the wavelet function φ_{a,b} (X) is. According to a value of a position b, a position at which the the wavelet function φ_{a,b} (x) is oscillated, is shifted. Accordingly, the above expression (3) means that the input signal f(x) is decomposed to the total sum of the wavelet function φ_{a,b} (x) having a various scales and positions.

As “the multiresolution transform which is a method of reducing the image size” among above-described types of the wavelet transforms, the orthogonal wavelet transform, biorthogonal wavelet transform are well known. The outline of the calculation of the orthogonal and biorthogonal wavelet transform will be described below.

$$\begin{matrix}\text{(Math-4)} & \\ {ψ}_{i , j} ( x ) = {2}^{- i} ψ ( \frac{x - j \cdot {2}^{i}}{{2}^{i}} ) & ( 4 )\end{matrix}$$

Where, i is a natural number.

When comparing the expression (4) to the expression (1), it can be seen that a value of the scale a is discretely defined by i-th power of 2, and further, the minimum movement unit of the position b is discretely defined by 2ⁱ in the orthogonal wavelet transform and the biorthogonal wavelet transform. This value of i is called a level.

When the level i is limited up to a finite upper limit N, the input signal f(x) is expressed as the following expressions (5)-(7).

$$\begin{matrix}\text{(Math-5)} & \\ f ( x ) ≡ {S}_{0} & ( 5 ) \\ = {\sum }_{j} ( {S}_{0} , {Ψ}_{1 , j} ) \cdot {Ψ}_{1 , j} ( x ) + {\sum }_{j} ( {S}_{0} , {ϕ}_{1 , j} ) \cdot {ϕ}_{1 , j} ( x ) & \\ ≡ {\sum }_{j} {W}_{1} ( j ) \cdot {Ψ}_{1 , j} ( x ) + {\sum }_{j} {S}_{1} ( j ) \cdot {ϕ}_{1 , j} ( x ) & \\ \text{(Math-6)} & \\ {S}_{i - 1} = {\sum }_{j} 〈 {S}_{i - {1}_{,}} {Ψ}_{{i}_{,} j} 〉 \cdot {Ψ}_{i , j} ( x ) + {\sum }_{j} 〈 {S}_{i - 1 ,} {ϕ}_{i , j} 〉 \cdot {ϕ}_{i , j} ( x ) & ( 6 ) \\ ≡ {\sum }_{j} {W}_{i} ( j ) \cdot {Ψ}_{i , j} ( x ) + {\sum }_{j} {S}_{i} ( j ) \cdot {ϕ}_{i , j} ( x ) & \\ \text{(Math-7)} & \\ f ( x ) ≡ {S}_{0} \text{=} \text{≡} {\sum }_{i = 1}^{N} {\sum }_{j} {W}_{i} ( j ) \cdot {ψ}_{i , j} ( x ) + {\sum }_{j} {S}_{N} ( j ) \cdot {ϕ}_{i , j} ( x ) & ( 7 )\end{matrix}$$

In the second term of the expression (5), the lower frequency band components of residuals which can not be expressed by the total sum of the wavelet function Φ_{l,j}(x) of level 1, are expressed by the total sum of the scaling function Φ_{l,j}(x) of level 1. An appropriate scaling function is used corresponding to the wavelet function. By applying the wavelet transform of level 1 shown in the expression (5), the input signal f(x)=S₀ is signal-decomposed to the higher frequency band components W₁ and the lower frequency band components S₁ of level 1.

Because the minimum shift unit of the wavelet function Φ_{i,j}(x) is 2ⁱ, the signal amounts of the higher frequency band components W₁ and the lower frequency band components S₁ are respectively 1/2 to the signal amount of the input signal S₀, and the total sum of the signal amounts of the higher frequency band components W₁ and the lower frequency band components S₁ equals to the signal amount of the input signal S₀. The lower frequency band components S₁ of level 1 are decomposed to the higher frequency band components W₂ and the lower frequency band components S₂ by the expression (6), and hereinafter, by repeating the transform up to the level N in the same manner, the input signal S₀, as shown in expression (7), is decomposed to the total sum of the higher frequency band components of level 1−N, and the sum of the lower frequency band components of level N.

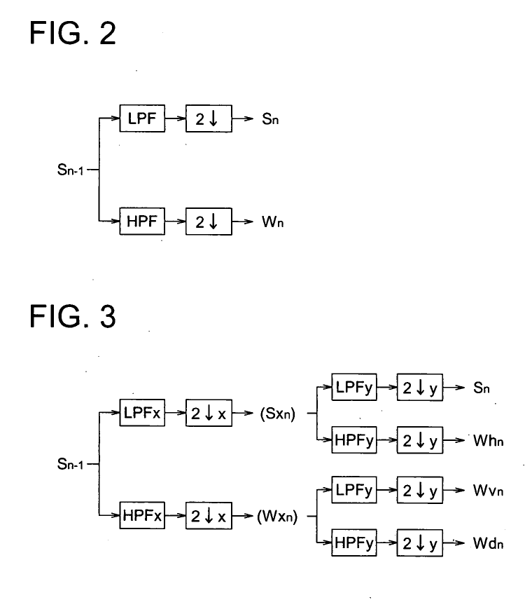

Herein, it is well known that the wavelet transform shown in the expression (6), can be calculated by the filter processing as shown in FIG. 2. In FIG. 2, an LPF shows a lower pass filter, and a HPF shows a high pass filter. Filer coefficients of the low pass filter LPF and the high pass filter are appropriately determined corresponding to the wavelet function. In FIG. 2, “2θ” shows the down sampling which thins out the signals every other.

As shown in FIG. 2, when the input signal Sₙ₋₁ is processed by the low pass filter LPF and the high pass filter HPF, and the signals are thinned out every other, the input signal Sₙ₋₁ can be decomposed to the higher frequency band components Wₙ and the lower frequency band components Sₙ.

The first level wavelet transform in the two dimensional signal as the image signal, is calculated by the filter processing as shown in FIG. 3. In FIG. 3, LPFx, HPFx and 2↓x show the processing in the x-direction, and LPFy, HPFy and 2↓y show the processing in the y-direction. Initially, the input signal Sₙ₋₁ is filter processed by the low pass filter LPFx and high pass filter HPFx, in the x-direction, and the down-sampling is applied in the x-direction. Hereby, the input signal Sₙ₋₁ is decomposed to the lower frequency band components SXₙ, and the higher frequency band components WXₙ. On each of the lower frequency band components SXₙ and the higher frequency band components WXₙ, the filter processing by the low pass filter LPFy and high pass filter HPFy in the y-direction is applied, and the down-sampling is applied in the y-direction.

By this first level wavelet transform, the lower frequency band components Sₙ₋₁ is decomposed to 3 higher frequency band components Whₙ, Wvₙ, Wdₙ, and 1 lower frequency band components Sₙ. Because each of signal amounts of Whₙ, Wvₙ, Wdₙ and Sₙ, which are generated by the decomposition is 1/2 in the length and width, as compared to Sₙ₋₁ before the decomposition, the total sum of the signal amounts of 4 components after the decomposition is equal to the signal of sₙ₋₁ before decomposition.

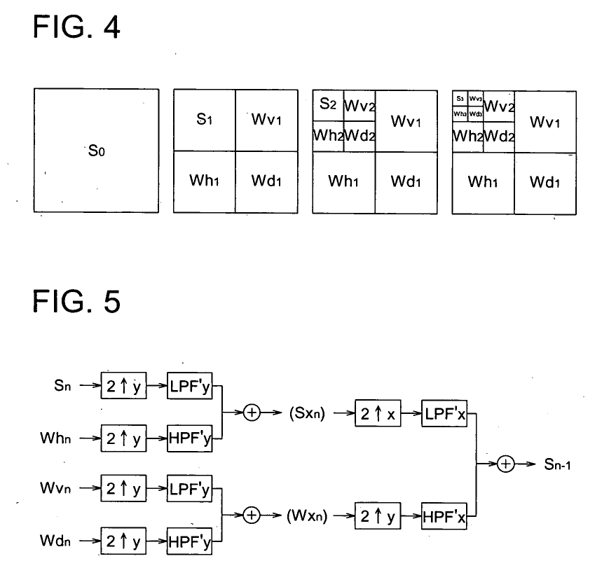

A process in which the input signal S₀ is signal-decomposed by the third level wavelet transform, is typically shown in FIG. 4. It can be seen that, as the number of level is larger, the image signal is thinned out by the down-sampling, and the decomposed image becomes small as shown in FIG. 4.

Further, as shown in FIG. 5, it is well known that the signal Sₙ₋₁ before the decomposition can be perfectly re-structured by applying the inverse wavelet transform calculated by the filter processing to Whₙ, Wvₙ, Wdₙ and Sₙ generated by the decomposition. In FIG. 5, LPF′ shows the low pass filter for the inverse transform, and HPF′ shows the high pass filter for the inverse transform. Further, “2↑” shows the up-sampling processing by which zero is inserted every other into the signal. Further, the LPF′x, HPF′x, 2↑x show a flow of the processing in the x-direction, and the LPF′y, HPF′y, 2↑y show a flow of the processing in the y-direction.

As shown in FIG. 5, SXₙ is obtained by adding the signal obtained by processing the up-sampling processing and filter-processing by the low pass filter LPF′y in the y-direction on Sₙ, and the signal obtained by applying the up-sampling processing and the filter-processing by the high pass filter HPF′y in the y-direction on Whₙ. In the same manner as this, WXₙ is generated from Wvₙ and Wdₙ.

Further, the signal Sₙ₋₁ before the decomposition can be re-structured by adding the signal obtained by applying the up-sampling processing and the filter processing by the low pass filter LPF′x in the x-direction on SXₙ, and the signal obtained by applying the up-sampling processing and the filter processing by the high pass filter HPF′x in the x-direction on WXₙ.

When the orthogonal wavelet transform has been applied, as a filter used for the inverse wavelet transform, a filter with the same coefficient as the coefficient used in the orthogonal wavelet transform is used. When the biorthogonal wavelet transform has been applied, a filter with the different coefficients from the coefficients used in the biorthogonal wavelet transform is used at the time of the inverse transform.

Next, an outline of a dyadic wavelet transform will be described. The wavelet function used in the dyadic wavelet transform is defined as the following expression (8).

$$\begin{matrix}\text{(Math-8)} & \\ {ψ}_{i , j} ( x ) = {2}^{- i} ψ ( \frac{x - j}{{2}^{i}} ) & ( 8 )\end{matrix}$$

Where, i is a natural number.

As described above, the minimum movement unit of the position at level i is discretely defined in the wavelet functions including the orthogonal wavelet transform and biorthogonal wavelet transform. However, in the dyadic wavelet transform, the minimum shift unit of the position is constant regardless of level i. By this difference, the dyadic wavelet transform has the following features.

As the first feature, each of signal amounts of the higher frequency band components Wᵢ and the lower frequency band components Sᵢ, generated by the first level dyadic wavelet transform shown in the following expression (9) is the same as the signal Sᵢ₋₁ before the transform.

$$\begin{matrix}\text{(Math-9)} & \\ {S}_{i - 1} = {\sum }_{j} 〈 {S}_{i - 1 ,} {ψ}_{i , j} 〉 \cdot {ψ}_{i , j} ( x ) + {\sum }_{j} 〈 {S}_{i - 1 ,} {ϕ}_{i , j} 〉 \cdot {ϕ}_{i , j} ( x ) & ( 9 ) \\ ≡ {\sum }_{j} {W}_{i} ( j ) \cdot {ψ}_{i , j} ( x ) + {\sum }_{j} {S}_{i} ( j ) \cdot {ϕ}_{i , j} ( x ) & \end{matrix}$$

Like this, the dyadic wavelet transform is different from the biorthogonal and orthogonal wavelet transform, and the image size after transform is not decreased from the original image.

As the second feature, the following relational expression (10) is satisfied for the scaling function φ_{i,j}(x) and the wavelet function φ_{i,j}(x).

$$\begin{matrix}\text{(Math-10)} & \\ {ψ}_{i , j} ( x ) = \frac{δ}{δ x} {ϕ}_{i , j} ( x ) & ( 10 )\end{matrix}$$

Accordingly, the higher frequency band components Wᵢ generated by the dyadic wavelet transform is expressed by the first order differentiation (gradient) of the lower frequency band components Sᵢ.

As the third feature, when Wi-γi (hereinafter, called the corrected higher frequency band components) is calculated by multiplying the higher frequency band components to the coefficient γᵢ (hereinafter, called correction coefficient) determined corresponding to the level i of the wavelet transform, corresponding to the singularity of a signal change of the input signal, the relationship between the levels of the signal density of the corrected higher frequency band components Wᵢ-γᵢ follows predetermined formula.

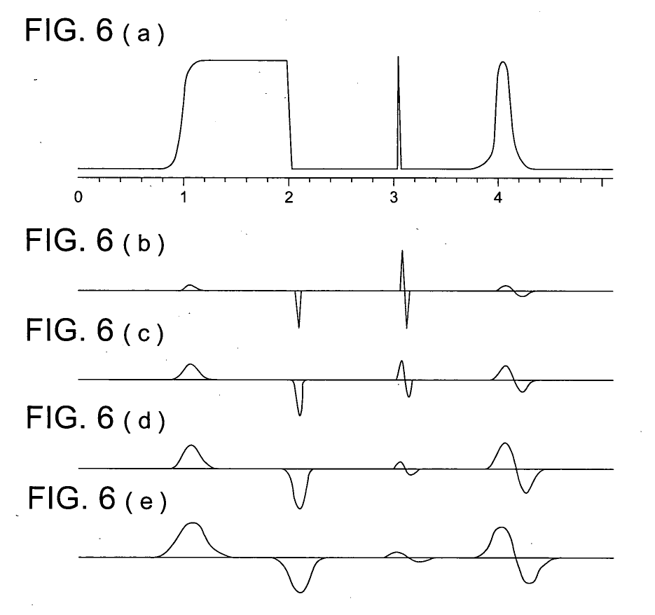

In FIGS. 6(a)-6(e), a waveform of the input signal So and a waveform of the corrected higher frequency band components of each level obtained by the wavelet transform are shown. FIG. 6(a) shows the input signal S₀, FIG. 6(b) shows the corrected higher frequency band components W₁-γ₁ obtained by the level-i dyadic wavelet transform, FIG. 6(c) shows the corrected higher frequency band components W₂-γ₂ obtained by the level-2 dyadic wavelet transform, FIG. 6(d) shows the corrected higher frequency band components W₃-γ₃ obtained by the level-3 dyadic wavelet transform, and FIG. 6(e) shows the corrected higher frequency band components W₄-γ₄ obtained by the level-4 dyadic wavelet transform.

When a change of the signal intensity in each level is observed, the corrected higher frequency band components Wᵢ-γᵢ is corresponding to a smooth (differentiable) signal variation shown in “1” or “4” in FIG. 6(a). The signal intensity of the corrected higher frequency band components Wᵢ-γᵢ, is increased as a value of i (level) is increased, as shown in FIGS. 6(b) through 6(e).

In the input signal S₀, the corrected higher frequency band components Wᵢ-γᵢ is corresponding to a step-like signal change shown in “2” of FIG. 6(a). The signal intensity of the corrected higher frequency band components Wᵢ-γᵢ becomes constant irrespective of a value of i. In the input signal S₀, the corrected higher frequency band components Wᵢ-γᵢ is corresponding to a δ-functional signal change shown in “3”. The signal intensity of the corrected higher frequency band components Wᵢ-γᵢ is reduced as a number of level i is increased, as shown in FIGS. 6(b) through 6(e).

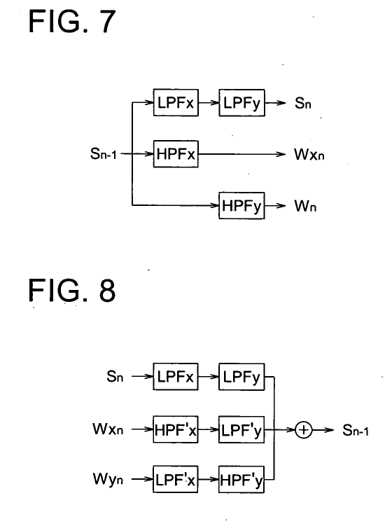

As the fourth feature, a method of the first level dyadic wavelet transform in the second dimensional signal as the image signal is different from the above-described orthogonal wavelet transform or the biorthonal wavelet transform, and applied by a method shown in FIG. 7.

As shown in FIG. 7, the lower frequency band components Sₙ is obtained by processing the input signal Sₙ₋₁ by the low pass filter LPFx in x direction and the low pass filter LPFy in y direction using the first level dyadic wavelet transform. Further, by processing the input signal Sₙ₋₁ is processed using the high pass filter in x direction, the higher frequency band components Wₓₙ are obtained. Further, by processing the input signal Sₙ₋₁ using the high pass filter HPFy in y direction, the another higher frequency band components W_{yn} are obtained.

In this manner, the input signal Sₙ₋₁ is decomposed to 2 higher frequency band components Wₓₙ, W_{yn}, and one lower frequency components Sₙ by the first level dyadic wavelet transform. The 2 higher frequency band components Wₓₙ, W_{yn} correspond to x component and y component of the change vector Vₙ in 2 dimension of the lower frequency band components Sₙ. The magnitude Mₙ and the deflection angle An of the change vector Vₙ are given in the following expressions (11) and (12).

$$\begin{matrix}\text{(Math-11)} & \\ {M}_{n} = \sqrt{W {x}_{n}^{2} + W {y}_{n}^{2}} & ( 11 )\end{matrix}$$

(Math-12)
An=arg(Wxₙ+iWyₙ) (12)

Further, when the inverse dyadic wavelet transform shown in FIG. 8 is applied to the 2 higher frequency band components Wxₙ and Wyₙ and one lower frequency band components Sₙ obtained by the dyadic wavelet transform, the signal Sₙ₋₁ before the transform can be re-structured. That is, the signal Sₙ₋₁ before the dyadic wavelet transform can be obtained by adding a signal obtained by processing Sₙ by the low pass filter LPFx in x-direction and the-low pass filter LPFy in y-direction, a signal obtained by processing Wxₙ by the high pass filter HPF′x in x-direction and the low pass filter LPF′y in y-direction, and a signal obtained by processing Wyₙ by the low pass filter LPF′x in x-direction and the high pass filter HPF′y in y-direction.

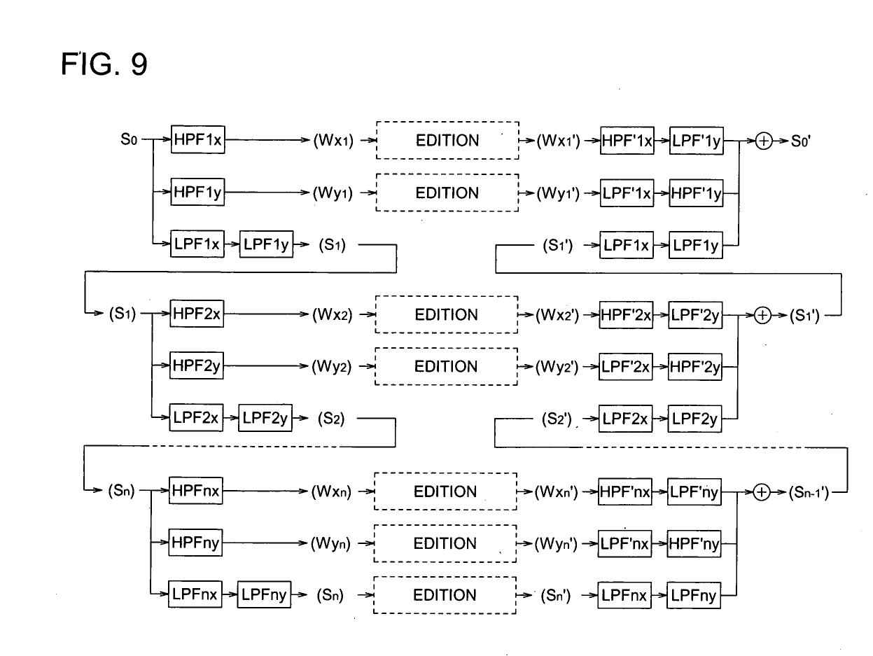

Next, according to the block diagram in FIG. 9, a method of obtaining the output signal S₀′ from the input signal S₀, such that after the n-th level (n is a natural number) dyadic wavelet transform is applied to the input signal S₀, and any one of image processing (in FIG. 9, “editing” is written) is applied to the obtained higher frequency components, lower frequency components, the n-th level inverse dyadic wavelet transform is applied, and the output signal S₀′ is obtained.

By the level-1 dyadic wavelet transform to the input signal S₀, the input signal S₀ is decomposed to the signal of 2 higher frequency band components Wx₁, Wy₁ and the lower frequency components S₁. The lower frequency band components S₁ obtained by the level-1 dyadic wavelet transform is further decomposed to 2 higher frequency band components Wx₂, Wy₂ and the lower frequency band components S₂ using the wavelet transform of level 2. When such a decomposition operation is repeated to the level n, the input signal S₀ is decomposed to a plurality of the higher frequency band components Wx₁, Wx₂, . . . , Wxₙ, Wy₁, Wy₂, . . . , Wyₙ and one lower frequency band components Sₙ.

After the image processing (editing) is applied to the higher frequency ban components Wx₁, Wx₂, . . . , Wxₙ, Wy₁, Wy₂, . . . , Wyₙ and one lower frequency band components Sn, which are obtained in this manner, the higher frequency band components Wx₁′, Wx₂′, . . . , WXₙ′, Wy₁′, Wy₂′, . . . , Wyₙ′ and one lower frequency band components Sₙ′ are obtained.

Then, the inverse dyadic wavelet transform is applied to these higher frequency band components Wx₁′, Wx₂′, . . . , Wxₙ′, Wy₁′, Wy₂′, . . . , Wyₙ′ and one lower frequency band components Sₙ′. That is, the lower frequency components Sₙ₋₁′ of the level 1 that has been processed by the image processing (editing), is structured from the 2 higher frequency band components Wxn′, Wyn′ in the level n and the lower frequency band components Sn′ in the level n, that have been processed by the image processing (editing). After such an operation is repeated, the lower frequency components S₁′ of the level 1 after the image processing is structured from the 2 higher frequency band components Wx₂′, Wy₂′ in the level 2 after the image processing, and the lower frequency band components S2′. From this the lower frequency band components S₁′ and 2 higher frequency band components Wx₁′, Wy₁′ in the level 1 after the image processing, the image signal S₀′ is structured.

Hereupon, a filter coefficient of each filter used in FIG. 9 is adequately determined corresponding to the dyadic wavelet transform. Further, in the dyadic wavelet transform, the filter coefficient used for each level is different. In the filter coefficients used in the level n, coefficients in which zeros of 2ⁿ⁻¹ pieces are inserted between each of coefficients of filters of level 1 are used.

Further, in FIG. 9, a flow of the image processing (editing) applied to the image of the higher frequency band components obtained by the dyadic wavelet transform and the lower frequency band components of the final level is shown, however, the image processing may be applied to the image of the lower frequency band components synthesized after the inverse dyadic wavelet transform. Furthermore, the image processing may also be applied to the image of the lower frequency band components on the halfway of the dyadic wavelet transform.

As “the multiresolution transform which is a method of reducing the image size” in embodiments written in items 14, 31, 48, it is preferable that the biorthogonal and orthogonal wavelet transform is used. Further, in the biorthogonal and orthogonal wavelet transform, because the image size of the lower frequency band component image after the transform can be made ¼ of the original image, it is preferable also from the view point of the processing load.

A phrase of “to reduce the signal intensity” in embodiments written in items 10, 14, 27, 31, 44, 48 means to process the absolute value of the signal intensity of pixels so that it is decreased. Further, the pixels whose “signal intensity variation is a predetermined threshold or below” may be selected, for example, by a threshold value determined according to a standard deviation σ of the signal intensity of the higher frequency band components, a threshold value determined by using the mean value, median, or mode of the signal intensity, or a threshold value obtained based on a comparison of the image signal of pixels corresponding to the image signal of the corrected higher frequency band components of the P-th level (P is a natural number) obtained by the dyadic wavelet transform, to the image signal of the corrected higher frequency band components of the (P+1)th level or the (P−1)th level.

Further, “the first” level and “the second” level written in each of items mean the number of times at which the multiresolution transform or the dyadic wavelet transform is applied.

According to embodiments written in items 1, 18, 35, the image signal expressing the color image is obtained, pixels forming the skin-colored area are extracted from pixels included in the image signal, and the image processing to reduce the variation amount of the signal intensity is applied to the pixels which have the spatial frequency within the specific range and have the variation amount of the signal intensity with a specific threshold value or below, among the extracted pixels. Because the sharpness feeling of the whole image is not deteriorated, further, the outline structure of the face of the person is not changed, the spotting or puckering can be removed without a sense of incompatibility.

Hereupon, as a threshold value of the range of the spatial frequency and a variation amount of the signal intensity, it is preferable that the threshold value is appropriately changed corresponding to the age, sex, gradation of the skin, an amount of spotting or puckering, of the person recorded in the image signal. Further, also for an adjusting amount to reduce the variation amount of the signal intensity, in the same manner, it is preferable that it is appropriately changed corresponding to the age, sex, gradation of the skin, an amount of spotting or puckering, of the person recorded in the image signal. Further, because the human puckering is many in the lateral direction (a parallel direction to the eyes and mouth), the puckering in the lateral direction may also be adjusted so that it can be intensively removed.

According to embodiments written in items 7, 24, 41, by converting the image signal into the brightness signal and the color difference signal, and applying the image processing reducing the variation amount of the signal intensity to the brightness signal and/or color difference signal of pixels forming the skin-colored area, the sharpness feeling of the whole image is not deteriorated, and the outline structure of the face of the person is not changed. Therefore, the spotting or puckering can be removed without a sense of the incompatibility. Hereupon, it is preferable that the image processing is applied to the brightness signal for the puckering or chapping of the skin of a person, and it is preferable that the image processing is applied to the color difference signal for the spotting or freckle.

According to embodiments written in items 8, 25, 42, by adjusting the contrast for the image signal of pixels forming the skin-colored area after the variation amount of the signal intensity in the signal intensity adjusting process is reduced, the image without a sense of incompatibility can be presented even when the result of the image processing of the present invention is perceived as if the contrast is changed.

According to embodiments written in items 9, 26, 43, by adding the noise signal to the image signal of pixels forming the skin-colored area after the variation amount of the signal intensity is reduced, the image without a sense of incompatibility can be presented even when, a result of the image processing of the present invention is perceived as if the contrast is changed.

According to embodiments written in items 10, 27, 44, the image signal expressing the color image is obtained, pixels forming the skin-colored area is extracted from the pixels included in the image signal, and the image signal is converted into the brightness signal and the color difference signal, the image processing for reducing the signal intensity is applied in case that the signal intensity of the image signal of at least level-2 higher frequency band components of pixels forming the skin-colored area is not larger than a specific threshold value among the frequency band components obtained by applying at least the second level dyadic wavelet transform is applied to the converted image signal and decomposing the image signal into the image signal with different frequency band components. Therefore, because the sharpness feeling of the whole image is not deteriorated and the outline structure of the face of the person is not changed, the spotting and the puckering can be removed without any sense of incompatibility.

Hereupon, it is preferable that the threshold value is appropriately changed corresponding to the age, sex, gradation of the skin, and an amount of the spotting or puckering, of the person recorded in the image signal as the threshold value of the signal intensity. Further, also for an adjusting amount to reduce the signal intensity, in the same manner, it is preferable that it is appropriately changed corresponding to the age, sex, gradation of the skin, and an amount of the spotting or puckering, of the person recorded in the image signal. Further, because the human puckering is many in the lateral direction (a parallel direction to the eyes and mouth), the puckering in the lateral direction may also be adjusted so that it can be intensively removed.

According to embodiments written in items 11, 28, 45, the dyadic wavelet transform is applied to the brightness signal and/or color difference signal to decompose the brightness signal and/or color difference signal into the image signal with the various frequency band components, and when the signal intensity of the image signal of at least level-2 higher frequency band components of pixels forming the skin-colored area is not larger than a specific threshold value, the image processing to reduce the signal intensity is applied. Therefore the sharpness feeling of the whole image is not deteriorated, further, the outline structure of the face of the person is not changed, the spotting and the puckering can be removed without any sense of incompatibility. Hereupon, for the puckering or freckle of the skin of a person, it is preferable that the image processing is applied to the brightness signal, and for the spotting or chapping, the image processing is applied on color difference signal.

According to embodiments written in items 12,29,46, the contrast is adjusted for the image signal of the lower frequency band components of pixels forming the skin-colored area among the image signals with the various frequency band components decomposed by the first level dyadic wavelet transform. Therefore, the image not having any sense of incompatibility can be presented even when a result of the image processing of the present invention is perceived as if the contrast is changed.

According to embodiments written in items 13, 30, 47, the noise signal is added to the image signal of pixels forming the skin-colored area after the variation amount of the signal intensity is reduced. The image not having any sense of incompatibility can be presented even when a result of the image processing of the present invention is perceived as if the contrast is changed.

According to embodiments written in items 14, 31, 49, the image signal expressing the color image is obtained, pixels forming the skin-colored area are extracted from the pixels included in the image signal of the lower frequency band components, among the various frequency band components obtained by applying the multiresolution transform at least at the first level which is a method of reducing an image size to the obtained image signal, and the image processing to reduce the signal intensity is applied when the signal intensity of the image signal of the higher frequency band components of pixels forming the skin-colored area is not larger than a specific threshold value among image signals with the various frequency band components obtained by applying at least first level dyadic wavelet transform to the image signal with the lower frequency band components. Therefore, the productivity of the processing can be increased because the image processing is applied after the image size is decreased, and further, the outline structure of the face of the person is not changed, the spotting and the puckering can be removed without any sense of incompatibility because the sharpness feeling of the whole image is not deteriorated.

Hereupon, it is preferable that the threshold value is appropriately changed corresponding to the age, sex, gradation of the skin, and an amount of the spotting or puckering, of the person recorded in the image signal as the threshold value of the signal intensity. Further, also for an adjusting amount to reduce the signal intensity, in the same manner, it is preferable that it is appropriately changed corresponding to the age, sex, gradation of the skin, and an amount of the spotting or puckering, of the person recorded in the image signal. Further, because the human puckering is many in the lateral direction (a parallel direction to the eyes and mouth), the puckering in the lateral direction may also be adjusted so that it can be intensively removed.

According to embodiments written in items 15, 32, 49, the image signal of the lower frequency band components obtained by the multiresolution transform is converted into the brightness signal and the color difference signal, and on the brightness signal and/or color difference signal, in the frequency band components obtained when at least the first level dyadic wavelet transform is applied, in the case where the signal intensity of the image signal of the higher frequency band components is not larger than a specific threshold value, when the image processing to reduce the signal intensity is applied, because the sharpness feeling of the whole image is not deteriorated, further, the outline structure of the face of the person is not changed, the spotting and the puckering can be removed without any sense of incompatibility. Hereupon, for the puckering or freckle of the skin of a person, it is preferable that the image processing is applied to the brightness signal, and for the spotting or chapping, the image processing is applied to the color difference signal.

According to embodiments written in items 16, 33, 50, the contrast is adjusted for the image signal of pixels forming the skin-colored area. Even when a result of the image processing of the present invention is perceived as if the contrast is changed, the image not having any sense of incompatibility can be presented.

According to embodiments written in items 17, 34, 51, the noise signal is added to the image signal of pixels forming the skin-colored area after the variation amount of the signal intensity is reduced. Even when a result of the image processing of the present invention is perceived as if the contrast is changed, the image not having any sense of incompatibility can be presented.

### DETAILED DESCRIPTION OF THE INVENTION

Referring to the drawings, the preferred embodiments to carry out the present invention will be detailed below. The external structure of the image processing apparatus 1:

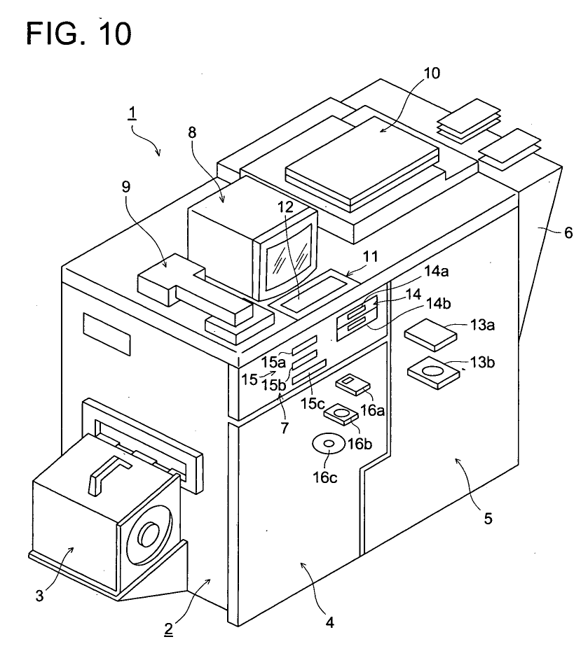

Initially, referring to FIG. 10, the external structure of an image processing apparatus will be described.

In the image processing apparatus 1, as shown in FIG. 10, a magazine loading section 3 is provided. On one side surface of a casing 2, the magazine loading section 3 for loading a photosensitive material is provided. Inside of the casing 2, an exposure processing section 4 for exposing the photosensitive material, and a print making section 5 for development processing the exposed photosensitive material and drying, and for making a print, are provided. On the other side surface of the casing 2, a tray 6 for discharging the print made in the print making section 5 is provided.

Further, on an upper portion of the casing 2, a CRT (Cathode Ray Tube) 8 as a display device, a film scanner section 9 which is a device for reading-in a transmission document, a reflection document input device 10, and an operation section 11 are provided. Further, in the casing 2, an image reading-in section 14 which can read the image information recorded in each kind of digital recording medium, and an image writing section 15 which can write an image signal in each kind of digital recording medium, are provided. Further, inside the casing 2, a control section 7 for overall-controlling each section of them is provided.

In the image reading-in section 14, an adapter for a PC card 14a, an adapter for a floppy disk (registered trade mark, same hereinafter) 14b are provided, and a PC card 13a or a floppy disk 13b can insert into them. For example, the PC card 13a has a memory in which the information of a plurality of frame images image-picked up by a digital camera is recorded. In the floppy disk 13b, for example, the information of a plurality of frame images image-picked up by the digital camera is recorded.

In the image writing section 15, an adapter 15a for the floppy disk, an adapter for MO (Magneto-Optical) 15b, an adapter 15c for an optical disk are provided, and respectively, a floppy disk 16a, MO 16b, and optical disk 16c can insert into them. As the optical disk 16c, there are a CD-R (CD Recordable), CD-RW (CD Rewritable), DVD±R, DVD±RW, and Blu-ray Disc.

Hereupon, in FIG. 10, a structure in which the operation section 11, CRT 8, film scanner section 9, reflection document input device 10, image reading section 14 are integrally provided in the casing 2, is applied, however, any one of them may also be provided as a separated body.

Hereupon, in the image processing apparatus 1 shown in FIG. 10, an apparatus which exposes the photosensitive material, develops, and makes a print, is illustrated, however, a print making method is not limited to this, for example, a system such as an inkjet system, electronic photographing system, heat sensitive system, sublimation system, may also be used.

Inside Structure of the Image Processing Apparatus 1:

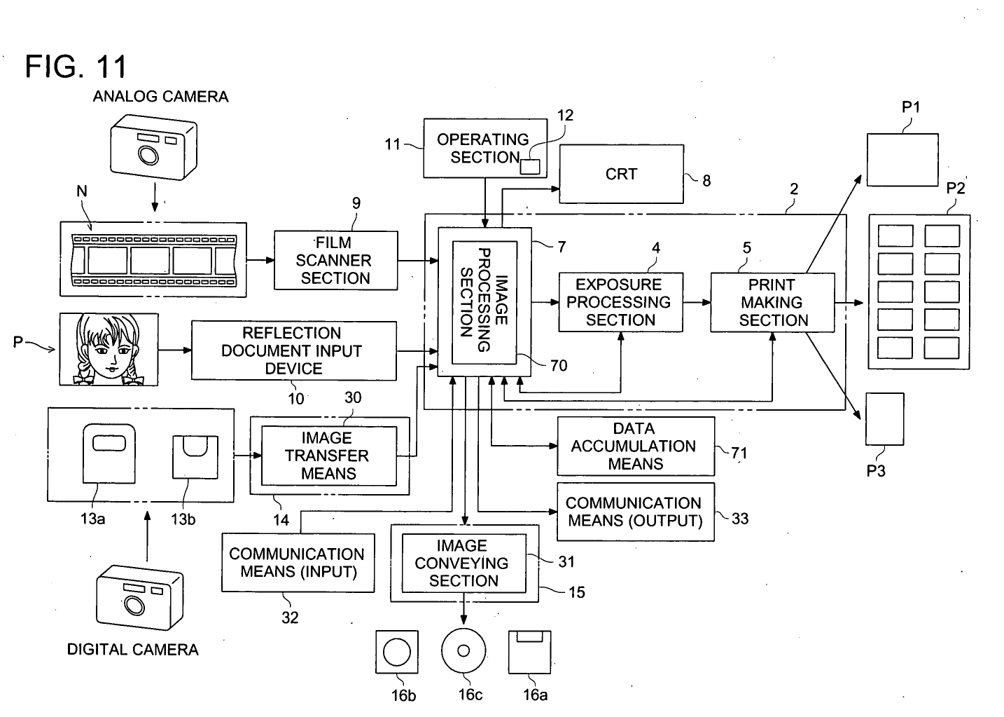

Next, referring to FIG. 11, an inside structure of the image processing apparatus 1 will be described. The image processing apparatus 1 is provided with, as shown in FIG. 11, the control section 7, exposure processing section 4, print making section 5, film scanner section 9, reflection document input device 10, image reading section 14, communicating means (input) 32, image writing section 15, data accumulation means 71, operating section 11, CRT 8, communicating means (output) 33.

The control section 7 is structured by a microcomputer, and each kind of control programs such as an image processing program stored in a ROM (Read Only Memory), (not shown), and by a cooperation with a CPU (Central Processing Unit), (not shown), an operation of each section structuring the image processing apparatus 1, is overall controlled.

The control section 7 has the image processing section 70, and according to the input signal (instruction information) from the operating section 11, to the image data obtained by the film scanner section 9 or the reflection document input device 10, image data read from the image reading section 14, and image data inputted from the external equipment through the communication means 32, forms the image information for exposure, and outputs to the exposure processing section 4. Further, the image processing section 70 applies the transform processing corresponding to the output mode on the image processed image data, and outputs it. As the output destination of the image processing section 70, there are the CRT 8, image writing section 15, communication means (output) 33, and data accumulation means 71.

The exposure processing section 4 exposes the image on the photosensitive material, and outputs it to the print making section 5. The making section 5 developing-processes the exposed photosensitive material, dries, and makes the prints P1, P2, P3. The print P1 is a print such as service size, hi-vision size, panorama size, the print P2 is a print of A4-size print, and the print P3 is a print of name card size.

The film scanner section 9 reads-in the information of the frame image from each kind of transmission-type documents such as the developed negative film or reversal film, image picked-up by an analog camera. The reflection document input device 10 reads-in each kind of images formed in the print P (photographic print).

The image reading section 14 has an image transfer means 30, and reads-out the frame image information recorded in the PC card 13a or floppy disk 13b, and transfers it to the control section 7. The image transfer means 30 has an adapter 14a for the PC card, and an adapter 14b for the floppy disk. The image reading section 14 reads out the information of the frame image recorded in the PC card 13a inserted into the adapter 14a for the PC card, or the floppy disk 13b inserted into an adapter 14b for the floppy disk, and transfers it to the control section 7 by using the image transfer means 30. As the adapter 14a for the PC card, for example, a PC card reader or a PC card slot is used.

The communication means (input) 32 receives an image signal expressing the picked-up image or a print command signal from another computer in the facility in which the image processing apparatus 1 is installed, or a remote computer through the internet.

The image writing section 15 is provided with an adapter 15a for the floppy disk, adapter 15b for MO, and adapter 15c for the optical disk, as the image conveying section 31. The image writing section 15, according to a writing signal inputted from the control section 7, writes each kind of data in the floppy disk 16a inserted into the adapter 15a for the floppy disk, MO 16b inserted into the adapter 15b for MO, and the optical disk 16c inserted into the adapter 15c for the optical disk.

The data accumulate means 71 accumulates the image information and an order information (the information in which, from which frame image, which number of prints are made, or the information of a print size) corresponding to it.

The operating section 11 has an information input means 12. The information input means 12 is structured by, for example, a touch panel, and outputs the pressing signal of the information input means 12 as the input signal to the control section 7. Hereupon, the operating section 11 may also be structured by providing a key-board or mouse. The CRT 8 displays the image information according to a display control signal inputted from the control section 7.

The communication means (output) 33 sends the image signal expressing the photographed image, and the order information accompanied to it, to another computer in the facility in which the image processing device 1 is installed, or a remote computer through internet. Structure of the image processing section 70:

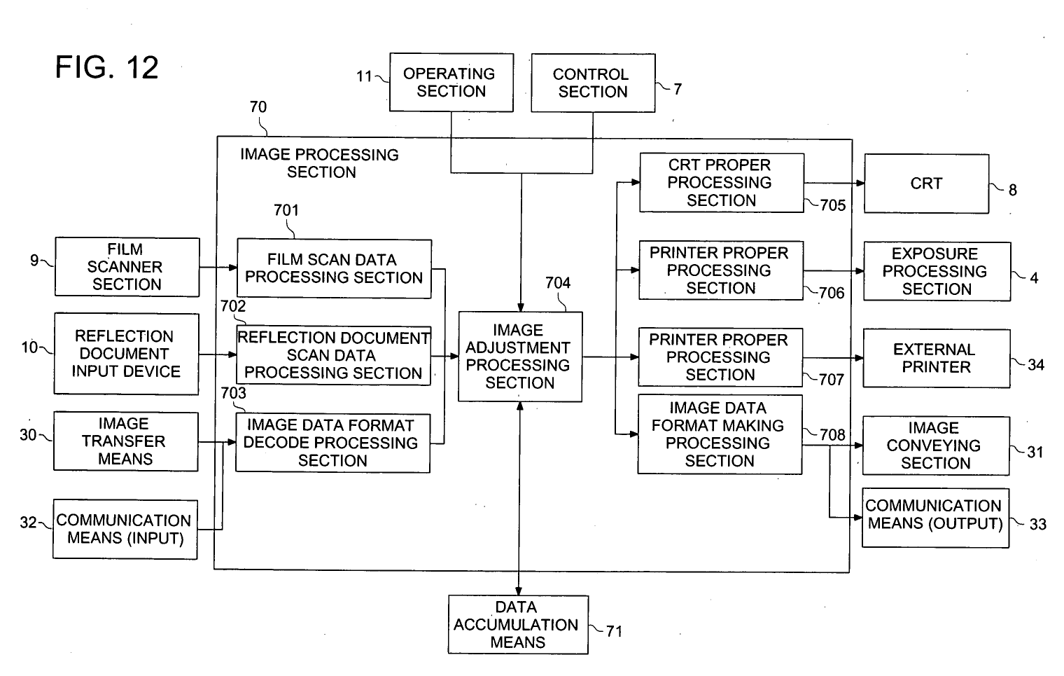

Next, referring to FIG. 12, a structure of the image processing section 70 will be described.

The image processing section 70 is, as shown in FIG. 12, provided with a film scan data processing section 701, reflection document scan data processing section 702, image data format decode processing section 703, image data adjustment processing section 704, CRT proper processing section 705, printer proper processing section 706, printer proper processing section 707, and image data format making section 708.

The film scan data processing section 701 applies a correction operation proper to the film scanner section 9, a negative positive reversal in the case of a negative document, a gray balance adjustment, a contrast adjustment, on the image information inputted from the film scanner section 9, and outputs it to the image adjustment processing section 704. Further, the film scan data processing section 701 also outputs the information relating to a film size, kind of negative film and positive film, ISO (International Organization for Standardization) sensitivity optically or magnetically recorded in the film, name of manufacturer, main object, the information relating to the photographing condition (for example, a content of the written information of APS (Advanced-Photo System)) in addition to it to the image adjustment processing section 704.

The reflection document scan data processing section 702 applies the correction operation proper to the reflection document input device 10, negative, positive reversal in the case of the negative document, gray balance adjustment, contrast adjustment on the image information inputted from the reflection document input device 10, and outputs it to the image adjustment processing section 704.

The image data format decode processing section 703 applies the reversion of the compression sign, transform of the expression method of the color data, according to the data format of the image data inputted from the image transfer means 30 or communication means (input) 32, and outputs it to the image adjustment processing section 704.

The image adjustment processing section 704 applies each kind of image processing on the image signal expressing the color image inputted from the film scanner section 9, reflection document input device 10, image transfer means 30, communication means (input) 32, according to a command of the operating section 11 or control section 7. Specifically, the image adjustment processing section 704 extracts the skin-colored area from the image signal when the skin-colored area of a person is included in the image signal.

Herein, the skin-colored area means a range of the skin such as a face or-neck of the person included in the image signal. Herein, the skin-colored area can be determined by an image area extracted by applying the simple range extension to the image signal in the lower frequency band components obtained by the dyadic wavelet transform on the image signal, or by an image area decided as the most suitable face by applying a logarithmic polar coordinate transform to around the most suitable eye of the object included in the image signal and applying the template matching or the simple area extension to the transformed image signal.

Further, the image adjustment processing section 704 converts the 3-color intensity signal of RGB of the image signal expressing the color image into the brightness signal and the color difference signal. The conversion into the brightness signal and the color difference signal may also be a method of converging an intensity signal for 3 colors of RGB representing the image signal of an object of the image processing into a intensity signal for the publicly known YIQ base or YUV base, or an intensity signal for XYZ base of the CIE 1931 color specification system or L*a*b base or L*u*V* base which is advised by CIE 1976 according to a standard such as sRGB (standard RGB) or NTSC (National TV Standards Committee). Further, it may also be a conversion such that an average of RGB values of the signal is defined to the brightness signal, and 2-axis perpendicular to the brightness signal is defined to a color difference signal.

Further, the image adjustment processing section 704 applies processing to reduce a variation amount of the signal intensity on pixels in which the spatial frequency is within a specific range, and the variation amount of the signal intensity is not larger than a specific threshold value. This reducing processing corresponds to the processing to remove the puckering or spotting included in the image signal of the higher frequency band components. Hereupon, even when the variation amount of the spatial frequency and the signal intensity is out of a specific range, a slightly weak reducing processing may also be applied to the variation amount of the signal intensity for the pixels in the vicinity of a specific range. Further, on the pixels not corresponding to even the pixels within the specific range and in the vicinity of the specific range, inversely, the processing to emphases the variation amount of the signal intensity may also be applied.

Herein, variation amounts of the spatial frequency and the signal intensity may be measured, by pasting the spatial frequency of a sinusoidal wave and a plurality of image signals on the image signal before the processing, using a soled retouch software, applying the image processing to the image signal, and measuring a change of an amplitude value after the processing to the amplitude value before processing.

Further, the image adjustment processing section 704 applies the adjustment of the contrast or a processing to add the noise signal.

Further, the image adjustment processing section 704 applies at least the second level dyadic wavelet transform to the image signal and decomposes the image signal into the frequency band components which are different from each other. Alternately, at least the first level multiresolution transform (for example, biorthogonal wavelet transform) which is a method of reducing the image size is applied to the image signal, and the image signal is decomposed into the image signal with various frequency band components, at least first level dyadic wavelet transform is further applied to the image signal of the lower frequency band components among decomposed components, the image signal of the lower frequency band components is decomposed into the image signal with the more various frequency band components. In this case, the image adjustment processing section 704 determines, the number of levels at which the the multiresolution transform which is a method of reducing the image size is decreased is switched to the dyadic wavelet transform according to the reading resolution of the image signal. According to the determined level number, the multiresolution transform and the dyadic wavelet transform are applied. Further, the inverse dyadic wavelet transform and the inverse multiresolution transform are applied to the image signal which has been applied the image processing.

The image adjustment processing section 704 outputs the image signal after the processing to the CRT proper processing section 705, printer proper processing section 706, printer proper processing section 707, image data format making processing section 708, and data accumulation means 71.

The CRT proper processing section 705 applies a processing such as a pixel number change, color matching, on the image signal after the image processing inputted from the image adjustment processing section 704, and outputs it to CRT 8 in accompany with each kind of display information.

The printer proper processing section 706 applies the correction processing proper to the printer, color matching, pixel number change, on the image signal after the image processing inputted from the image adjustment processing section 704, and outputs it to the exposure processing section 4.

When an external printer 34 such as an inkjet printer is connected to the image processing apparatus 1 of the present invention, the printer proper processing section 707 is provided for each of connected printers. This printer proper processing section 707 applies the correction processing proper to the printer, color matching, pixel amount change, on the image after the-image processi ng inputted from the image adjustment processing section 704.

The image data format making processing section 708 transforms the image adjustment processing section 704 into each kind of general use image formats represented by JPEG (Joint Photographic Experts Group), TIFF (Tagged Image File Format), Exif (Exchangeable Image File Format) on the image signal after the image processing inputted, and outputs it to the image conveying section 31, or communication means (output) 33.

Hereupon, a division like as the film scan data processing section 701, reflection document scan data processing section 702, image data format decode processing section 703, image adjustment processing section 704, CRT proper processing section 705, printer proper processing sections 706 and 707, image data format making processing section 708, is a division provided for a help of an understand of the functions of the image processing section 70 of the present embodiment, and it is not necessarily to be realized as a physically independent device. For example, it may also be realized as a division of the kind of a single software processing. Further, the image processing apparatus 1 in the present embodiment is not limited to the above-described content, but it can be applied to various embodiments such as a digital photo-printer, printer driver, plug-in of each kind of image processing software.

Next, as a specific execution method of the processing to remove the puckering or spotting, carried out in the image adjustment processing section 704 in FIG. 12, an example in which dyadic wavelet transform which is one of the wavelet transform, is used, will be described by dividing into Example 1 and Example 2.

### EXAMPLE 1

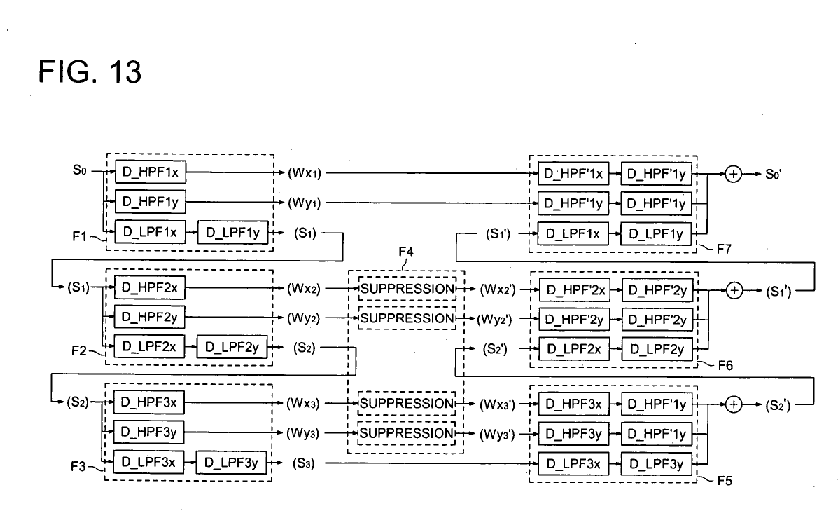

Referring to FIG. 13, operations in the present example will be described below. Operations described in the present example are applied by the image adjustment processing section 704. The present example 1 shows an example for removing the puckering or spotting is removed from the portrait, in which pixels forming the skin-colored area are extracted from pixels included in the image signal expressing the obtained color image, and the image signal expressing the color image is converted into the brightness signal and the color difference signal, and on the converted brightness signal, the third level dyadic wavelet transform is applied, and in the image signal of the frequency band components which are different from each other, obtained by level-2 and level-3 dyadic wavelet transforms, when the signal density of the image signal of the higher frequency band components of prior obtained pixels forming the skin-colored area is not larger than a specific threshold level, an example in which, by applying the processing to reduce the signal intensity.

Initially, pixels forming the skin-colored area are extracted from pixels included in the image signal, and the image signal is decomposed to the brightness signal S₀ and the color difference signal (not shown). On the brightness signal S₀, the level-1 dyadic wavelet transform is applied through a filter group F1, and the brightness signal S₀ is decomposed to image signals Wₓ₁, W_{y1} of the higher frequency band components and the image signal S₁ of the lower frequency band components. In the same manner, on the image signal S₁ of the lower frequency band components, the level-2 dyadic wavelet transform is applied through a filter group F2, and the image signal S₁ is decomposed to image signals Wₓ₂, W_{y2} of the higher frequency band components and the image signal S₂ of the lower frequency band components, further, on the image signal S₂ of the lower frequency band components, the level-3 dyadic wavelet transform is applied through a filter group F3, and the image signal S₂ is decomposed to image signals Wₓ₃, W_{y3} of the higher frequency band components and the image signal S₃ of the lower frequency band components.

In this case, from image signals Wₓ₂, W_{y2}, Wₓ₃, W_{y3} in the higher frequency band components decomposed by the level-2 and level-3 dyadic wavelet transforms, the standard deviations σ of the absolute value of the signal intensity of the image signals of pixels forming the previously extracted skin-colored area are respectively calculated, and the threshold values which are references of the removing processing of the puckering or spotting are determined. Then, when image signals of pixels forming the skin colored area included in each of image signals Wₓ₂, W_{y2}, Wₓ₃, W_{y3}, of the higher frequency band components have the signal intensity not larger than threshold values, the processing to reduce the signal intensity of pixels is applied (refer to F4 in the drawing), the attenuation processed image signals Wₓ₂′, W_{y2}′ Wₓ₃′, W_{y3}′ are respectively generated.

Next, Wₓ₃′, W_{y3}′ and the image signal S₃ of the lower frequency band components are level-3 inverse wavelet transformed through a filter group FS, and S₂′ is generated, next, Wₓ₂′, W_{y2}′ and S₂′ are level-2 inverse wavelet transformed through a filter group F6, and S₁′ is generated, and next, Wₓ₁, W_{y1} and S₁′ are level-1 inverse wavelet transformed through a filter group F7, and S₀′ is generated. Herein, S₀′ is a brightness signal in which the puckering or spotting is removed from the brightness signal S₀. After that, the brightness signal S₀′ and the color difference signal (not shown) are converted into RGB signal, and the color image signal in which the puckering or spotting is removed, can be obtained.

Herein, filter groups F1-F3 respectively apply level-1, 2, 3 dyadic wavelet transforms to the input signal, and filter groups F5-F7 respectively apply level-3, 2, 1 inverse dyadic wavelet transforms to the input signal.

In each of filters of filter groups F1-F3 and F5-F7, D_HPFkl, D_HPF′kl (k=1, 2, . . . n (n is a natural number); 1=x, y) are high pass filters, D_LPFkl, D_LPF′kl (k=1, 2, . . . n (n is a natural number); 1=x, y) are low pass filters. An example of the high pass filter and low pass filter is shown in Table 1.

TABLE 1

| c | D_HPFl | D_LPFl | D_HPF′l | D_LPF′l |
|---|---|---|---|---|
| −3 | | | 0.0078125 | 0.0078125 |
| −2 | | | 0.054685 | 0.046875 |
| −1 | | 0.125 | 0.171875 | 0.1171875 |
| 0 | −2.0 | 0.375 | −0.171875 | 0.65625 |
| 1 | 2.0 | 0.375 | −0.054685 | 0.1171875 |
| 2 | | 0.125 | −0.0078125 | 0.046875 |
| 3 | | | | 0.0078125 |

In Table 1, a filter coefficient of c=0 is a filter coefficient for pixels processing at this time, filter coefficient of c=−1 is a filter coefficient for one-preceding pixels to pixels processing at this time, and a filter coefficient of c=+1 is a filter coefficient for one-succeeding pixels to pixels processing at this time.

In the dyadic wavelet transform, the filter coefficient is different for each level. For the filter coefficient of level-i, a coefficient in which 2ⁱ⁻¹ zeros are inserted between respective coefficients of filters of level-1, is used.

Further, an example of the correction coefficient γᵢ determined corresponding to the level-i of the dyadic wavelet transform is shown in Table 2.

TABLE 2

| i | γ |
|---|---|
| 1 | 0.66666667 |
| 2 | 0.89285714 |
| 3 | 0.97087379 |
| 4 | 0.99009901 |
| 5 | 1 |

Hereupon, even when, the change of contrast is not applied to the color image signal from which the puckering and spotting obtained by the above processing are removed, there is a case where it is perceived as if the contrast is changed depending on conditions such as largeness and brightness of the face of a person included in the image signal. Therefore, the processing to change the contrast is applied to the image signal of the lower frequency band components obtained by the level-1 dyadic wavelet transform of pixels included in the skin-colored area. Alternatively, the processing to add the faint noise signal to the image signal is applied to the image signal of pixels included in the skin-colored area of the processed color image signal. When such a processing is applied, the contrast without visually a sense of incompatibility can be maintained. Hereupon, it is described herein that either one of the change of contrast or the addition of noise signal is applied, however, both processing may also be applied, or both processing may also not be applied.

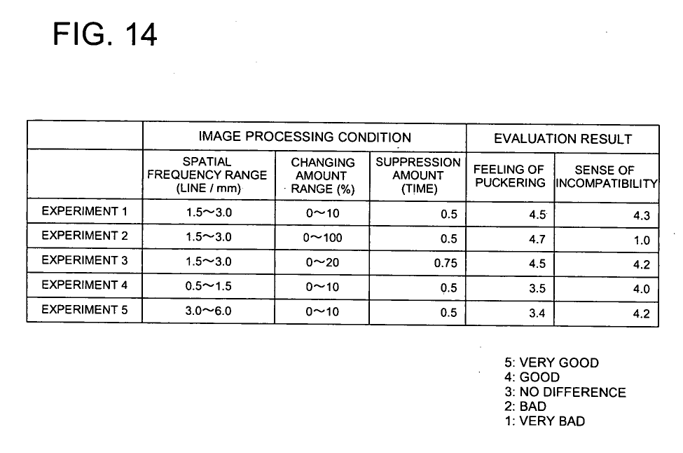

In FIG. 14, an example of the image evaluation result in the present example 1 is shown. FIG. 14 shows after the image processing of the present example 1 is applied to the image signal in which the object is recorded, after the face of 20-ages woman which is an object, is photographed in 2656 pixels*3992 pixels (approximate 10,600×10³ pixels) by using Phase One H10 camera pack (made by Phase One co.) for Mamiya RZ67 Pro2 (made by Mamiya Co.) camera, the image evaluation result when it is outputted on the 2L-sized silver halide printing paper in the output resolving power of about 300 dpi.

In the evaluation result of FIG. 14, 5 kinds of image processing (experiment 1-experiment 5) with various image processing conditions are different are applied, and the mean value of 5-grade evaluation by 10 subjects is made as the evaluation result. Herein, by indexes of a feeling of the puckering and a sense of incompatibility, a grade of removal of the puckering or spotting of the image, a sense of incompatibility for the image are respectively shown. Five kinds of image processing are attained by changing the level of the wavelet to reduce the signal intensity, the suppression amount to reduce the signal intensity, and the threshold value of the signal intensity to be reduced.

Herein, the image processing condition shows a range of the spatial frequency of the image signal, a range of a variation amount of the signal intensity to the maximum signal variation amount, a value of suppression amount to multiply a changing mount of the signal intensity to reduce the signal intensity. The spatial frequency corresponds to the frequency of the image signal of the higher frequency band components of each level obtained by the dyadic wavelet transform, and the variation amount range corresponds to the signal intensity of the image signal of the higher frequency band components obtained at each level. Herein, the maximum signal variation amount means the maximum value of the variation amount of the signal intensity (signal value), for example, in the case of 8-bit system, because the signal value of the image signal can take the range of 0-255, the maximum signal variation amount is 255.

According to the evaluation result shown in FIG. 14, the evaluation result when the image processing is applied by the image processing conditions of the experiment 1 and the experiment 3, is higher than the evaluation result by the other experiments 2, 4, 5. It indicates that it is preferable that the suppression processing to reduce the variation amount of the signal intensity to 0.5 times-0.75 times is applied, to the pixels in which the variation amount of the signal intensity is within a range of 0-20% of the maximum signal variation amount.

As described above, according to the image processing apparatus 1 of Example 1, when pixels forming the skin-colored area is extracted from pixels included in the obtained image signal, and the obtained image signal is decomposed to the brightness signal and the color difference signal, and the level-1 through level-3 dyadic wavelet transforms are applied to the decomposed brightness signal and color difference signal, and to pixels of the skin-colored area in which the spatial frequency of the image signal of the higher frequency band components obtained by the level-2 and level-3 dyadic wavelet transform is 1.5-3.0 lines/mm, and the variation amount of the signal intensity is within the range of 0-20% of the maximum signal variation amount, the processing to reduce the variation amount of the signal intensity is applied, because a sense of sharpness of the whole image is not deteriorated, further, the outline structure of the face of a person is not changed, the spotting or puckering can be removed without a sense of incompatibility.

Hereupon, in the present Example 1, although the processing to reduce the variation amount of the signal intensity is applied, it is not limited to this. A slightly weak suppression processing may also be applied to the variation amount of the signal intensity, for the pixels which are in the vicinity of a specific range, even when variation amounts of the spatial frequency and the signal intensity are out of a specific range. Further, inversely, the processing to emphasize the variation amount of the signal intensity may also be applied to pixels which does not correspond to also ones within a specific range and in the vicinity of a specific range.

Further, in the present Example 1, although the level-1 through level 3 dyadic wavelet transforms and the processing to reduce the signal intensity is applied to only the brightness signal, it is not limited to this. It may also be applied to only the color difference signal, and may also be applied to both the brightness signal and the color difference signal.

Further, it is preferable that the number of levels for applying the dyadic wavelet transform is appropriately changed correspondingly to the kind of objects included in the image signal, number of pixels of the image signal, and output size of the output resolving power.

### EXAMPLE 2

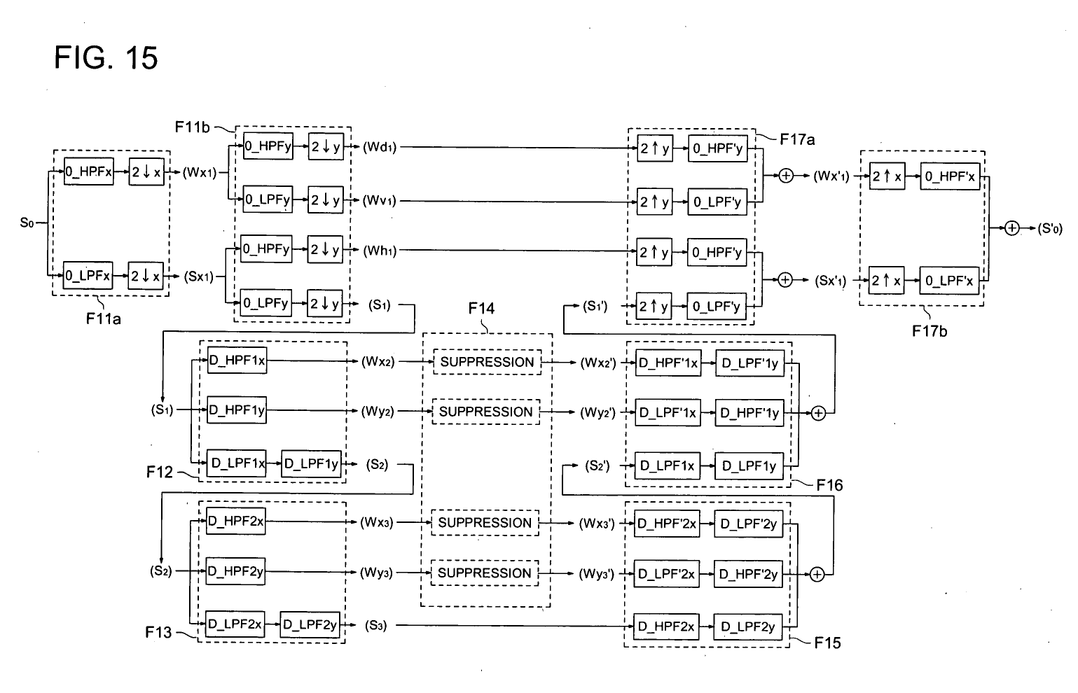

Next, referring to FIG. 15, operations in Example 2 will be described. Operations described in the present Example 2 are applied by the image adjustment processing section 704. The present Example 2 shows the first level biothogonal wavelet transform is applied to the image signal expressing the obtained color image, and in image signals of 2 different wavelength band components obtained by the 1-level biothogonal wavelet transform, from pixels included in the image signal of the lower frequency band components, pixels forming the skin-colored area are extracted, and the image signal of the lower frequency band components is converted into the brightness signal and the color difference signal, and the second level dyadic wavelet transform is applied to the converted brightness signal, and in the image signal of the frequency band components which are different from each other, obtained by the level-2 and level-3 dyadic wavelet transform, when the signal intensity of the image signal of the higher frequency band components of pixels forming the skin-colored area previously obtained, is not larger than a specific threshold value, by applying the processing to reduce the signal intensity, an example in which the puckering or spotting is removed from the portrait.

Initially, the level-1 biorthogonal wavelet transform is applied through the filter groups F11a and F11b to the image signal So. Herein, the image signal So is decomposed to the image signal Wₓ₁ of higher frequency band components and the image signal Sₓ₁ of lower frequency band components through the filter group F11a, and further, Wₓ₁ is decomposed to the image signals W_{d1} and Wᵥ₁ of higher frequency band components through the filter group F11b, and Sₓ₁ is decomposed to the image signal Wₕ₁ of higher frequency band components and the image signal S₁ of lower frequency band components. Next, pixels forming the skin-colored area are extracted from pixels included in the decomposed image signal S₁ of the lower frequency components, and the image signal S₁ of the lower frequency components is converted into the brightness signal and the color difference signal. In FIG. 15, the converted brightness signal is re-defined as S₁.

Next, on the brightness signal S₁, the level-2 dyadic wavelet transform is applied through the filter group F12, and the brightness signal S₁ is decomposed to the image signals Wₓ₂, W_{y2} of the higher frequency band components, and the image signal S₂ of the lower frequency components, further, on the image signal S₂ of the lower frequency components, the level-3 dyadic wavelet transform is applied through the filter group F13, and the image signal S₂ is decomposed to image signals Wₓ₃, W_{y3} of the higher frequency band components and the image signal S₃ of the lower frequency band components.

In this case, from image signals Wx2, Wy2, Wx3, Wy3 of the higher frequency band components decomposed by the level-2 and level-3 dyadic wavelet transforms, the standard deviations σ of the absolute values of the signal intensity of the image signal of pixels forming the skin colored area previously extracted, are respectively calculated, and the threshold value which is the reference of the removal processing of the puckering and spotting, is determined. Then, when the image signal of pixels forming the skin colored area included in each of image signals Wₓ₂, W_{y2}, Wₓ₃, W_{y3} of the higher frequency band components has the signal density not larger than the threshold value, the processing to reduce the signal intensity of pixels is applied (refer to the sign F14 in the drawing), and the attenuation processed image signals Wₓ₂′, W_{y2}′, Wₓ₃′, W_{y3}′ are respectively generated.

Next, on Wₓ₃′, W_{y3}′ and the image signal S₃ of the lower frequency band components, the level-3 inverse dyadic wavelet transform is applied through the filter group F15, and S₂′ is generated, next, on Wₓ₂′, W_{y2}′ and the image signal S₂′, the level-2 inverse dyadic wavelet transform is applied through the filter group F16, and S₁′ is generated, and the brightness signal S₁′ and color difference signal (not shown) are converted into RGB signal, and the image signal S₁′ (re-defined) of the lower frequency band components in which the puckering and spotting have been removed, can be obtained.

Next, on W_{d1}, Wᵥ₁, Wₕ₁ and S₁′, the level-1 inverse biorthogonal wavelet transform is applied through the filter group F17a and the filter group F17b. Herein, W_{d1} and Wᵥ₁ are generated in Wₓ₁, Wₕ₁ and S₁′ are generated in Sₓ₁′, respectively through the filter F17a, and further, Wₓ₁ and Sₓ₁′ are generated in the image signal S₀′ expressing the color image from which the puckering and spotting are removed, through the filter group 17b.

Herein, the filter group F11 applies the level-1 biorthogonal wavelet transform on the input signal, and the filter groups F12 and F13 respectively apply the level-2, 3 dyadic wavelet transform on the input signal. Further, filter groups F15 and F16 respectively apply the level-3, 2 inverse dyadic wavelet transform on the input signal, and the filter group F17 applies the level-1 inverse biorthogonal wavelet transform.

In each of filters of the filter groups F11 and F17, O_HPF1, O_LPFl (1=x, y) are respectively the high pass filter and low pass filter for biorthogonal wavelet transform, and O_HPF′1, O_LPF′l are respectively the high pass filter and low pass filter for inverse biorthogonal wavelet transform. An example of the high pass filter and low pass filter is shown in Table 3.

TABLE 3

| c | O_HPF | O_LPF | O_HPF′ | O_LPF′ |
|---|---|---|---|---|
| −4 | | 0.037829 | −0.037829 | |
| −3 | −0.064539 | −0.023849 | −0.023849 | −0.064539 |
| −2 | 0.04069 | −0.110624 | 0.110624 | −0.04069 |
| −1 | 0.418092 | 0.377403 | 0.377403 | 0.418092 |
| 0 | −0.788485 | 0.852699 | −0.852699 | 0.788485 |
| 1 | 0.418092 | 0.377403 | 0.377403 | 0.418092 |
| 2 | 0.04069 | −0.110624 | 0.110624 | −0.04069 |
| 3 | −0.064539 | −0.023849 | −0.023849 | −0.064539 |
| 4 | | 0.037829 | −0.037829 | |

In Table 3, a filter coefficient of c=0 is a filter coefficient for pixels processing at this time, filter coefficient of c=−1 is a filter coefficient for one-pixels preceding pixels to pixels processing at this time, and a filter coefficient of c=+1 is a filter coefficient for one-pixels succeeding pixels to pixels processing at this time. Hereupon, for the simplification of the description, the filter coefficients D_HPFkl, D_HPF′kl, D_LPFkl, D_LPF′kl, (k=1, 2, . . . , n (n is a natural number); 1=x, y) for the dyadic wavelet transform and the inverse dyadic wavelet transform are expressed by the same name as Example 1, and an example of the filters is shown in Table 1. Further, an example of the correction coefficient γᵢ is shown in Table 2.

Herein, there is a case where the processed color image signal is perceived as if the contrast is changed, depending on conditions such as the largeness of the face of a person included in the image signal, and the brightness even a case where the change of the contrast is not applied. Therefore, the processing to change the contrast is applied to the image signal of pixels included in the skin-colored area of the extracted lower frequency band components. Alternatively, the processing to add the faint noise signal to it, is applied to the image signal of pixels included in the skin-colored area of the processed color image signal. By applying such a processing, the contrast visually not having a sense of incompatibility can be maintained. Hereupon, it is described herein that either one of the change of contrast or the addition of noise signal is applied, however, both processing may also be applied, or both processing may also not be applied.

As described above, according to the image processing apparatus 1 of Example 2, the biorthogonal wavelet transform which is the multiresolution transform which is a method decreasing the image size is applied to the obtained image signal, and the skin-colored area is extracted from the image signal of the lower frequency band components obtained by the transform, and the image signal of the lower frequency band components is decomposed to the brightness signal and the color difference signal. Further, on the image signal of pixels corresponding to the skin-colored area of the image signal of the higher frequency band components obtained when the dyadic wavelet transforms are applied to the converted brightness signal, when the signal intensity is not larger than a specific threshold value, the processing to reduce the signal intensity and to suppress, is applied. When processed in this manner, the image size is decreased and the productivity of the processing can be increased, and because a sense of sharpness of the whole image is not deteriorated, further, the outline structure of the face of a person is not changed, the spotting and puckering can be removed without a sense of incompatibility.

Hereupon, in the present Example 2, although the level-2, 3 dyadic wavelet transforms and the processing to reduce the signal intensity are applied to only the brightness signal, it is not limited to this. It may also be applied to only the color difference signal, or may also be applied to both the brightness signal and the color difference signal.

Hereupon, the content of description in the detailed description to carry out the present invention, can be appropriately modified and changed within a scope which does not depart from the true spirit of the present invention.

1. An image processing method, comprising:
an obtaining step of obtaining an image signal representing a color image;
an extracting step of extracting pixels which form a skin colored area from pixels which are included in the obtained image signal;
a signal intensity adjusting step of reducing a variation amount of a signal intensity of a pixel whose spatial frequency is in a predetermined range and whose signal intensity variation amount is a predetermined threshold value or below among the extracted pixels.

2. An image processing method of claim 1,
wherein the extracting step extracts pixels which form a skin colored area by applying a dyadic wavelet transform to the obtained image signal and applying a simple area expansion to a lower frequency band component of the transformed image signal.

3. An image processing method of claim 1,
wherein the spatial frequency within the predetermined range is obtained by a higher frequency band component calculated by a multiresolution transform.

4. An image processing method of claim 3,
wherein the signal intensity adjusting step determines the predetermined threshold value based on a statistic value calculated by the higher frequency band component of an image signal intensity.

5. An image processing method of claim 4, wherein the statistic value is one of a standard deviation, an average, a median and a mode.

6. The image processing method of claim 1,
wherein when a pixel among the extracted pixels has a spatial frequency of 1.5-3.0 lines/mm and a signal intensity variation is in a range between 0-20% of a maximum signal intensity, the signal intensity adjusting step reduces a variation amount of a signal intensity of the pixel by 0.5-0.75 times.

7. The image processing method of claim 1, further comprising:
a color information converting step of converting the obtained image signal into a brightness signal and a color-difference signal,
wherein the signal intensity regulating step is applied to the brightness signal and/or the color-difference signal of the extracted pixels which form a skin colored area.

8. The image processing method of claim 7, further comprising:
a contrast controlling step of controlling a contrast of an image signal of the extracted pixels which form a skin colored area and whose image signal is reduced in the signal intensity adjusting step.

9. The image processing method of claim 7, further comprising:
a noise adding step of adding a noise signal to the image signal of the extracted pixels which form a skin colored area and whose image signal is reduced by the signal intensity regulating step.

10. An image processing method of claim 1, further comprising:
a color information converting step of converting the obtained image signal into a brightness signal and a color-difference signal; and
a wavelet transform step of decomposing the converted image signal into image signals with different frequency band components by applying at least a second level dyadic wavelet transform to the converted image signal,
wherein when an image signal intensity in at least a higher frequency band component at level 2 of the extracted pixels among the decomposed frequency band components is predetermined threshold value or below, the image intensity adjusting step reduces the signal intensity.

11. The image processing method of claim 10, wherein the wavelet transform step applies the dyadic wavelet transform to the brightness signal and/or the color-difference signal.

12. The image processing method of claim 11, further comprising a contrast controlling step of controlling a contrast of a image signal in the lower frequency band component of the extracted pixels which form a skin colored area among the image signals with different frequency band components decomposed by at least a first level of dyadic wavelet transform in the wavelet transform step.

13. The image processing method of claim 11, further comprising:
a noise adding step of adding a noise signal to the image signal of the extracted pixels which form a skin colored area and whose image signal is reduced by the signal intensity regulating step.

14. An image processing method of claim 1, further comprising: a first transform step and a second transform step,
wherein the first transform step decomposes the obtained image signal into image signals with different frequency band components by applying at least the first level multiresolution transform which is a method of reducing an image size,
the extracting step extracts pixels which form skin colored area from pixels included in the image signal with a lower frequency band component among image signals with different frequency band components decomposed by the multiresoluting transform,
the second transform step decomposes the image signal with the lower frequency band component into image signals with different frequency band components using at least a first level dyadic wavelet transform, and
when an intensity of an image signal in a higher frequency band component of the extracted pixels which form a skin colored area among image signals in different frequency band components decomposed by the dyadic wavelet transform, the signal intensity adjusting step reduces the signal intensity.

15. The image processing method of claim 14, further comprising:
a color information converting step of converting the image signal with a lower frequency band component among the decomposed frequency band components into a brightness signal and a color-difference signal,
wherein the second transform step applies at least a first level dyadic wavelet transform to the brightness signal and/or the color-difference signal.

16. The image processing method of claim 15, further comprising a contrast controlling step of controlling a contrast of a image signal of the extracted pixels which form a skin colored area.

17. The image processing method of claim 15, further comprising:
a noise adding step of adding a noise signal to the image signal of the extracted pixels which form a skin colored area and whose image signal is reduced by the signal intensity regulating step.

18. An image processing apparatus, comprising:
an obtaining section of obtaining an image signal representing a color image;
an extracting section of extracting pixels which form a skin colored area from pixels which are included in the obtained image signal;
a signal intensity adjusting section of reducing a variation amount of a signal intensity of a pixel whose spatial frequency is in a predetermined range and whose signal intensity variation amount is a predetermined threshold value or below among the extracted pixels.

19. An image processing apparatus of claim 18,
wherein the extracting section extracts pixels which form a skin colored area by applying a dyadic wavelet transform to the obtained image signal and applying a simple area expansion to a lower frequency band component of the transformed image signal.

20. An image processing apparatus of claim 18,
wherein the spatial frequency within the predetermined range is obtained by a higher frequency band component calculated by a multiresolution transform.

21. An image processing apparatus of claim 20,
wherein the signal intensity adjusting section determines the predetermined threshold value based on a statistic value calculated by the higher frequency band component of an image signal intensity.

22. An image processing apparatus of claim 21, wherein the statistic value is one of a standard deviation, an average, a median and a mode.

23. The image processing apparatus of claim 18,
wherein when a pixel among the extracted pixels has a spatial frequency of 1.5-3.0 lines/mm and a signal intensity variation is in a range between 0-20% of a maximum signal intensity, the signal intensity adjusting section reduces a variation amount of a signal intensity of the pixel by 0.5-0.75 times.

24. The image processing apparatus of claim 18, further comprising:
a color information converting section of converting the obtained image signal into a brightness signal and a color-difference signal,
wherein the signal intensity regulating section is applied to the brightness signal and/or the color-difference signal of the extracted pixels which form a skin colored area.

25. The image processing apparatus of claim 24, further comprising:
a contrast controlling section of controlling a contrast of an image signal of the extracted pixels which form a skin colored area and whose image signal is reduced in the signal intensity adjusting section.

26. The image processing apparatus of claim 24, further comprising:
a noise adding section of adding a noise signal to the image signal of the extracted pixels which form a skin colored area and whose image signal is reduced by the signal intensity regulating section.

27. An image processing apparatus of claim 18, further comprising:
a color information converting section of converting the obtained image signal into a brightness signal and a color-difference signal; and
a wavelet transform section of decomposing the converted image signal into image signals with different frequency band components by applying at least a second level dyadic wavelet transform to the converted image signal,
wherein when an image signal intensity in at least a higher frequency band component at level 2 of the extracted pixels among the decomposed frequency band components is predetermined threshold value or below, the image intensity adjusting section reduces the signal intensity.

28. The image processing apparatus of claim 27, wherein the wavelet transform section applies the dyadic wavelet transform to the brightness signal and/or the color-difference signal.

29. The image processing apparatus of claim 28, further comprising a contrast controlling section of controlling a contrast of a image signal in the lower frequency band component of the extracted pixels which form a skin colored area among the image signals with different frequency band components decomposed by at least a first level of dyadic wavelet transform in the wavelet transform section.

30. The image processing apparatus of claim 28, further comprising:
a noise adding section of adding a noise signal to the image signal of the extracted pixels which form a skin colored area and whose image signal is reduced by the signal intensity regulating section.

31. An image processing apparatus of claim 18, further comprising: a first transform section and a second transform section,
wherein the first transform section decomposes the obtained image signal into image signals with different frequency band components by applying at least the first level multiresolution transform which is a apparatus of reducing an image size,
the extracting section extracts pixels which form skin colored area from pixels included in the image signal with a lower frequency band component among image signals with different frequency band components decomposed by the multiresoluting transform,
the second transform section decomposes the image signal with the lower frequency band component into image signals with different frequency band components using at least a first level dyadic wavelet transform, and
when an intensity of an image signal in a higher frequency band component of the extracted pixels which form a skin colored area among image signals in different frequency band components decomposed by the dyadic wavelet transform, the signal intensity adjusting section reduces the signal intensity.

32. The image processing apparatus of claim 31, further comprising:
a color information converting section of converting the image signal with a lower frequency band component among the decomposed frequency band components into a brightness signal and a color-difference signal,
wherein the second transform section applies at least a first level dyadic wavelet transform to the brightness signal and/or the color-difference signal.

33. The image processing apparatus of claim 32, further comprising a contrast controlling section of controlling a contrast of a image signal of the extracted pixels which form a skin colored area.

34. The image processing apparatus of claim 32, further comprising:
a noise adding section of adding a noise signal to the image signal of the extracted pixels which form a skin colored area and whose image signal is reduced by the signal intensity regulating section.

35. An image processing program for use in a computer executing an image processing, comprising:
an obtaining step of obtaining an image signal representing a color image;
an extracting step of extracting pixels which form a skin colored area from pixels which are included in the obtained image signal;
a signal intensity adjusting step of reducing a variation amount of a signal intensity of a pixel whose spatial frequency is in a predetermined range and whose signal intensity variation amount is a predetermined threshold value or below among the extracted pixels.

36. An image processing program of claim 35,
wherein the extracting step extracts pixels which form a skin colored area by applying a dyadic wavelet transform to the obtained image signal and applying a simple area expansion to a lower frequency band component of the transformed image signal.

37. An image processing program of claim 35,
wherein the spatial frequency within the predetermined range is obtained by a higher frequency band component calculated by a multiresolution transform.

38. An image processing program of claim 37,
wherein the signal intensity adjusting step determines the predetermined threshold value based on a statistic value calculated by the higher frequency band component of an image signal intensity.

39. An image processing program of claim 38, wherein the statistic value is one of a standard deviation, an average, a median and a mode.

40. The image processing program of claim 35,
wherein when a pixel among the extracted pixels has a spatial frequency of 1.5-3.0 lines/mm and a signal intensity variation is in a range between 0-20% of a maximum signal intensity, the signal intensity adjusting step reduces a variation amount of a signal intensity of the pixel by 0.5-0.75 times.

41. The image processing program of claim 35, further comprising:
a color information converting step of converting the obtained image signal into a brightness signal and a color-difference signal,
wherein the signal intensity regulating step is applied to the brightness signal and/or the color-difference signal of the extracted pixels which form a skin colored area.

42. The image processing program of claim 41, further comprising:
a contrast controlling step of controlling a contrast of an image signal of the extracted pixels which form a skin colored area and whose image signal is reduced in the signal intensity adjusting step.

43. The image processing program of claim 41, further comprising:
a noise adding step of adding a noise signal to the image signal of the extracted pixels which form a skin colored area and whose image signal is reduced by the signal intensity regulating step.

44. An image processing program of claim 35, further comprising:
a color information converting step of converting the obtained image signal into a brightness signal and a color-difference signal; and
a wavelet transform step of decomposing the converted image signal into image signals with different frequency band components by applying at least a second level dyadic wavelet transform to the converted image signal,
wherein when an image signal intensity in at least a higher frequency band component at level 2 of the extracted pixels among the decomposed frequency band components is predetermined threshold value or below, the image intensity adjusting step reduces the signal intensity.

45. The image processing program of claim 44, wherein the wavelet transform step applies the dyadic wavelet transform to the brightness signal and/or the color-difference signal.

46. The image processing program of claim 45, further comprising a contrast controlling step of controlling a contrast of a image signal in the lower frequency band component of the extracted pixels which form a skin colored area among the image signals with different frequency band components decomposed by at least a first level of dyadic wavelet transform in the wavelet transform step.

47. The image processing program of claim 45, further comprising:
a noise adding step of adding a noise signal to the image signal of the extracted pixels which form a skin colored area and whose image signal is reduced by the signal intensity regulating step.

48. An image processing program of claim 35, further comprising: a first transform step and a second transform step,
wherein the first transform step decomposes the obtained image signal into image signals with different frequency band components by applying at least the first level multiresolution transform which is a program of reducing an image size,
the extracting step extracts pixels which form skin colored area from pixels included in the image signal with a lower frequency band component among image signals with different frequency band components decomposed by the multiresoluting transform,
the second transform step decomposes the image signal with the lower frequency band component into image signals with different frequency band components using at least a first level dyadic wavelet transform, and
when an intensity of an image signal in a higher frequency band component of the extracted pixels which form a skin colored area among image signals in different frequency band components decomposed by the dyadic wavelet transform, the signal intensity adjusting step reduces the signal intensity.

49. The image processing program of claim 48, further comprising:
a color information converting step of converting the image signal with a lower frequency band component among the decomposed frequency band components into a brightness signal and a color-difference signal,
wherein the second transform step applies at least a first level dyadic wavelet transform to the brightness signal and/or the color-difference signal.

50. The image processing program of claim 49, further comprising a contrast controlling step of controlling a contrast of a image signal of the extracted pixels which form a skin colored area.

51. The image processing program of claim 49, further comprising:
a noise adding step of adding a noise signal to the image signal of the extracted pixels which form a skin colored area and whose image signal is reduced by the signal intensity regulating step.
